(19) United States
(12) Patent Application Publication
(10) Pub. No.: US 2023/0131942 A1
(43) Pub. Date: Apr. 27, 2023

(54) SYSTEM AND METHOD FOR MANAGING, DISCOVERING AND SHARING STREAMING VIDEO SERVICES

(71) Applicant: Glidr Inc., Mountain View, CA (US)

(72) Inventors: William L. THOMAS, Aurora, CO (US); Joel Zdepski, Mountain View, CA (US); Paul Milazzo, Hockessin, DE (US); Michael Taylor, Mountain View, CA (US); Adam Tom, San Francisco, CA (US); Chris Lee, West Chester, PA (US); Tom Woods, Burlington, WI (US)

(73) Assignee: Glidr Inc., Mountain View, CA (US)

(21) Appl. No.: 18/049,633

(22) Filed: Oct. 26, 2022

Related U.S. Application Data
(60) Provisional application No. 63/272,180, filed on Oct. 27, 2021.

(51) Int. Cl. H04N 21/25; H04N 21/258; H04N 21/222; H04N 21/24

(52) U.S. Cl. CPC H04N 21/251; H04N 21/25875; H04N 21/222; H04N 21/2407

(57) ABSTRACT

A comprehensive system for assisting users of streaming services is provided. The system is implemented in a client/server environment. Users can manage their streaming service credentials, centralize their service information, discover new services and their video content, and share information with their friends and family. Budget and service optimization is provided.

### CROSS REFERENCE TO RELATED APPLICATION

This application claim the priority benefit of U.S. Provisional Application Ser. No. 63/272,180, which was filed on Oct. 27, 2021 and titled SYSTEM AND METHOD FOR MANAGING, DISCOVERING AND SHARING STREAMING VIDEO SERVICES by William THOMAS et al., the entire disclosure of which is incorporated herein by reference.

### FIELD OF TECHNOLOGY

This disclosure relates generally to systems for streaming video content and, more specifically, to management of streaming service credentials, discovery of streaming services and content, and sharing of information.

### BACKGROUND

The rapidly evolving consumer media consumption patterns are well-documented. The big television screen is more important than ever, but other mediums easily substitute, from computer screens to tablets to mobile phones to home speakers with screens. Traditional cable and satellite (Pay TV) providers still provide a myriad of programming, from local to cable nets to video on demand, both subscription and transactional, but consumers are increasingly looking elsewhere.

Some consumers complement their standard Pay TV package with streaming services such as Netflix, Hulu, Amazon Prime and YouTube. Some consumers shift their viewing from Pay TV to streaming services but keep their legacy programming around by moving to skinnier bundles such as Hulu Live, Sling, and YouTube TV. Still, others move completely away and assemble various packages from streaming service providers to mix and match with over-the-air broadcasters.

The problem is that all of this quality content is spread across multiple providers, from Netflix to Amazon Prime, from Hulu to Disney+ and HBO Max. None of these services, when considered individually, seems like a significant purchase. Services range from $6 to $15/month each and even higher at >$50/month when “live television” is included in the bundle. There are hundreds of such services now available for the consumer.

So, while many consumers have cut the cord (or are considering cutting the cord) to save on their monthly video entertainment budget, it doesn't take too many combined subscriptions to the various streaming services to ultimately pay a similar or higher amount than they were paying with their legacy service providers. This is particularly true if they subscribe to one of the vMVPDs such as SlingTV, DIRECTV stream, YouTube Tv and Hulu Live. Costs add up quickly, and we cannot forget the additional cost of a high-speed internet connection by which to receive all these services.

Even if the consumer is initially satisfied with their choice of services, monthly subscription prices change (mostly increasing), highly desirable shows/series end, content is moved from one service to another, consolidation and rebranding of services occurs, all of which confuse the consumer. Further, it's not easy to search for shows or movies and find out what service is carrying the content. Even within a service, the search feature behaves differently from one service to another, and of course when you are searching within a service, you won't see content carried by other services.

Once a consumer signs up for services, it's rare for them to review their choices unless or until a more compelling service is announced, at which point the tradeoff is not easy to make. “Do I simply pay for the new services, or do I drop an existing service?” Inertia carries the consumer forward—how many have dropped HBO Max once Game of Thrones was over . . . are they waiting for the next season of Westworld? Many consumers can't even remember what services they have signed up for, and how much they are spending each month across all their services. If they want to pause or cancel a service, it is not easy to find out how to do that.

There are online search products such as Reelgood, JustWatch, IMDb, and others, but they only help with a few aspects of the overall problem. There are other products such as My Bundle.TV and CobbleCord that provide initial guidance on what services to subscribe to, but they fall short of satisfying the full problem facing consumers.

Therefore, what is needed is a system and method that analyzes and learns the viewing interests of the consumer and helps manage their service subscriptions on a continuous basis. Further, the system and method provide the ability to discover and find new services and content. In addition, the system and method need to facilitate social interactions regarding viewing recommendations and cost sharing between friends and family.

### SUMMARY

Various embodiments of The Glidr system are described to assist users in managing their streaming services. This includes an onboarding experience, ongoing cost tracking and management, and assisting in subscribing, pausing, and cancelling a service. Automatic retrieval of user account information such as service level, cost, billing period, usage, viewing history, and watch list are provided. There are optimization techniques described for ensuring that the user has the most relevant content available for viewing from the services they are subscribed to.

As additional functionality, providing tools for discovering suitable services, video content, such as movies or shows of interest and deep linking directly into the player application for that content.

As additional functionality, various social features such as chat, sharing of service credentials and cost sharing for subscribed services. Providing an ability to share information regarding subscribed services, current viewing, Watchlists, with family and friends, as well as on popular social platforms like Facebook and Twitter.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates the high-level architecture of the service management, discovery, and social system in accordance with the various aspects and examples of the invention.

FIG. 2 illustrates a device-based user proxy use for retrieving user account information in accordance with the various aspects and examples of the invention.

FIG. 3 illustrates a 4-layer social graph of content, content publishers, users, and social interaction in accordance with the various aspects and examples of the invention.

FIG. 4 depicts an on-boarding user experience for indicating what services the user has subscribed to in accordance with the various aspects and examples of the invention.

FIGS. 5A-5C depict a Service Dashboard, including My Services for Active, Paused, and Wishlist services in accordance with the various aspects and examples of the invention.

FIGS. 6A-6B depict the Service Dashboard, including All Services and Service Plans in accordance with the various aspects and examples of the invention.

FIGS. 7A-7C depict various user statistics in accordance with the various aspects and examples of the invention.

FIG. 8 depicts the aggregated User Wishlist in accordance with the various aspects and examples of the invention.

FIG. 9 illustrates a budget optimization process in accordance with the various aspects and examples of the invention.

FIG. 10 illustrates a persona space for determining optimizations in accordance with the various aspects and examples of the invention.

FIG. 11 illustrates the architecture of the metadata management system in accordance with the various aspects and examples of the invention.

FIGS. 12A-12C illustrate the Prefix Search functionality for TV Series, Movie and Celebrities in accordance with the various aspects and examples of the invention.

FIGS. 13A-13B depict the Search user experience for a TV Series in accordance with the various aspects and examples of the invention.

FIGS. 14A-14B depict the Search user experience for a Streaming Service provider in accordance with the various aspects and examples of the invention.

FIG. 15 depicts the user Chat experience in accordance with the various aspects and examples of the invention.

FIG. 16 depicts a Friends Recommendation for a TV Series in accordance with the various aspects and examples of the invention.

FIGS. 17A-17C depict various Friends features in accordance with the various aspects and examples of the invention.

FIG. 18 depicts a Notification experience in accordance with the various aspects and examples of the invention.

FIG. 19 depicts an Advertising promotion in accordance with the various aspects and examples of the invention.

FIGS. 20A-20C depict Multimedia content sharing in accordance with the various aspects and examples of the invention.

### DETAILED DESCRIPTION

The terms “Glidr,” “the Glidr platform,” “the Glidr system,” and “system” may be used interchangeably in this disclosure. Also, the terms Nest, groups of friends and/or family are used with equivalent meaning. Friends, family, and “friends and family” are used interchangeably throughout this disclosure. Friends and family used singularly are also equivalent.

### The Glidr System

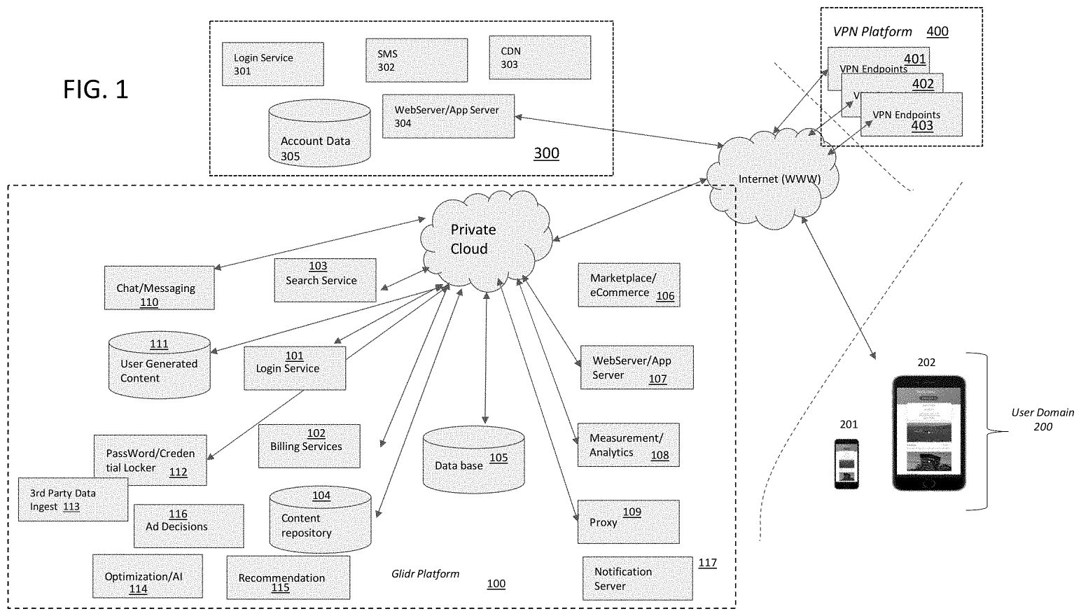

FIG. 1 provides an overview of many of the primary components of the Glidr system. It consists of 4 main domains of systems which interoperate to create a unique and useful experience for the end user. They are: 100 the Glidr Platform comprising a set of functions to implement the service, 200 the user Glidr application, 300 one of a plurality of streaming services with which the user has an account, and 400 a VPN network which provides the user with digital presence in different localities. The figure illustrates 1 User, 1 Service Provider (SP), and 3 VPN endpoints but this is simply for ease of representation. There are 100's of SP's, 1000's of VPN endpoints and 10's of millions of Users. Note that the user Glidr application 200 can be implemented on a variety of platforms, including a personal computer via a native app, or browser. It can also be provided as an Android or Apple Smartphone application. It can also be a Smart TV or Streaming Device such as a Roku or Android TV adapter. It could also be incorporated into a settop box such as those used by cable or satellite providers.

It is without a loss of generality or a change to the functionality of the platform or this invention, that each of the components in FIG. 1 could be further subdivided (as in micro service architecture), implemented as a combination of 1 or more of the subsystems, or to have a complete subsystem or portion thereof located in another domain perhaps within the control of 3rd parties' infrastructure. A very common example might be for Login Service 101 to actually be replicated multiple places where other entities perform this function. This is especially common where OAuth Login is used with Facebook, Google, or LinkedIn login while a generic username and password (or email address and password) login is provided within the primary platform for those users who do not want to exploit login validation from other of their services. Another case where functionality may incorporate a 3rd party service is User Generated Content 111. Content uploaded to other platforms such as TikTok, Instagram, YouTube, etc. may also be published via URL's and links to a user's circle of friends and acquaintances.

### The Glidr Platform

The full Glidr Platform 100 consists of services running in a public, private or hybrid cloud. In FIG. 1 it is illustrated as implemented in a private cloud, but an implementation on AWS with secure access is equally valid and, in some cases, preferred. Most of the functionally is accessed through RESTful API's where possible. There are notable exceptions where deviation from this implementation choice may be required or desirable. For example, Chat and other communications are intrinsically connection-based communications. In addition, for performance reasons some database access may be via integrated software libraries. One skilled in system design will recognize these variations as implementation decisions that are not germane to the invention. In this section a short overview of each subsystem is provided.

Login Service 101 is used by client applications running on user device(s) 201 or 202 to initiate access platform functionality. User account credentials are stored in database 105 along with personalization information. The user may wish to login with an alternative service provider's credentials such as Facebook or Google, in which case 101 communicates with 301 and ultimately enables the user to enter the state of Logged In. Billing Service 102 initiates billing and payment for any of the system features which are billed on a subscription of pay-per-use basis. Search Service 103 provides the user with search functionality for data stored in any of the accessible databases. FIG. 1 shows 3 databases 104, 105 and 111. Database 105 is to be understood for the purposes of this invention of a broadly defined Database for all types of information required for proper system operation or of interest to the user. A significant repository of Metadata about content and services are resident within and accessible to the user through both natural language or keyword search methods. Additionally, other subsystems within the system may generate automatic search queries through 103's REST interfaces.

Content Repository 104 is a repository of rich media used in the service. This includes, but is not limited to Still Pictures, videos, audio files and animations with associated metadata as appropriate. Some of the content may be by reference only. Database 105 is the primary data storage with the system. It can be implemented with a mix of technologies and is indicative of persistent data storage in general. This is inclusive of stored user account information, preferences, social graphs, meta-data, transaction records, calendars, articles, influencer recommendations and testimonials, etc. In short storage of any and all data useful for implementing the Glidr service. Marketplace 106 is a subsystem aggregating commercial offerings in the form of a storefront with offerings available for acquisition with traditional currency, crypto currency or points via fixed prices or auction. Users can also acquire items gifted to them by other persons or entities.

Web/Application Server 107 serves application components to the user 200. While shown as a single component in FIG. 1, its implementation can be further subdivided without reducing its utility. Some users will access the service from a web page while others will access it through a native application (e.g. iOS or Android) and 107 will respond appropriately. Server 107 interacts with all other servers directly or via shared storage Database 105 according to the requirements of the UEX 200.

Measurement/Analytics server 108 processes usage data/logs and as well as 3rd Party information ingested by 113 and creates reports and visualizations for the user, Glidr, and 3rd Party Partners. This will span the space of operational effectiveness of system components, financial efficiency of the user's subscriptions, and market trends and insights.

Proxy server 109 performs functions on Streaming platform 300 such as login to service through 304. It may persist sessions over multiple days by retaining cookies and certificates in database 105. It also retrieves user specific data such as Watch History and Watchlist from 305 and stores copies or digests of said data into 105.

The Glidr platform supports direct chat and messaging between users and groups of users who form their own groups of friends. The Chat Server 110 handles all traffic. It may make use of Notifications Server 117 to alert users that new chat is available, delivered or read.

User Generated Content is stored by server 111, either directly or by reference. Users may create content through other means such as TikTok, Instagram or Snap Chat and include them by reference or URL, or content may be stored on the Glidr Platform. Some user generated content examples are audio, video and written blogs. Users Credentials for services are saved securely by Credential Locker 112. Proxy 109 and Web/App Server 107 access credentials for logging into Streaming Service 300.

Third Party Content Ingest 113 imports data, optionally transforms it, and stores the result in 105. Typical content sources include but are not limited to Metadata about Programs, Episodes, Movies, Actors, Directors, Channels, Service Providers, and all things related to content. Further information includes opinion and reviews from critics and Influencers, reporters, etc.

Recommendations for content and services can be made to Users based on AI algorithms, rules-based algorithms, and other Optimization algorithms. Optimization Server 114 implements of variety of algorithms with inputs of User Preferences, User History, Critics Recommendations, Trends and Popularity, and trends within the users Social Graph as constructed from their Chat acquaintances and other connections and associations derived from activity on the platform.

Recommendations developed in part by 114 are provided the user through Recommendation Server 115. The Recommendations made may also be part of a Campaign to inform the entire or a subset of the User Population of new content, new services, or other changes to the Entertainment ecosystem. Ad Decision Server 116 implements Campaigns of Advertisement, Sponsorship within the User population, broadly or narrowly as required. Notification Server 117 can address users through omni-channel communications such as App Notifications, Text, email, or Chat.

### User Proxy

A key component of the system is the User Proxy 109. This sub system is used to emulate the user for various interactions with a streaming service. For example, it can retrieve account information such as service level and cost, billing date, viewing history and Watchlist. This is done with the user's permission, but otherwise they are not involved. It performs this function by logging into the service as if it were the user on a periodic basis as needed to keep the information up to date. Some challenges with this approach are that the services try to determine if a login is legitimate, to prevent hacking and misuse of the service. The Glidr system performs this task by emulating the service subscriber retrieving his/her actual information. Services have a variety of methods to determine a legitimate login, such as device type, IP address and human timed button presses. The following techniques will be used to achieve a legitimate device and IP address.

### Server Based Proxy

A simple solution is to use a centralized server for proxy 109. Proxy server 109 performs functions on Streaming platform 300 such as login to service through 304. This may work with some streaming services, but it's likely that they will detect a large number of login sessions from the same server IP address, which could be flagged as a security issue. As such, the Glidr system employs a more efficient approach.

Operation with VPN

The more efficient Glidr approach utilizes a VPN platform 400. A VPN 400 is used for the proxy which will have the same source IP address each time it retrieves information for a specific user. The proxy accesses the service though its IP address and returns the results back to the proxy. From the point of view of the service, the user is accessing the service from the VPN IP address. The Proxy simply accesses through a standard VPN 400 and there is no transformational processing except for security.

### Operation with an Embedded VPN

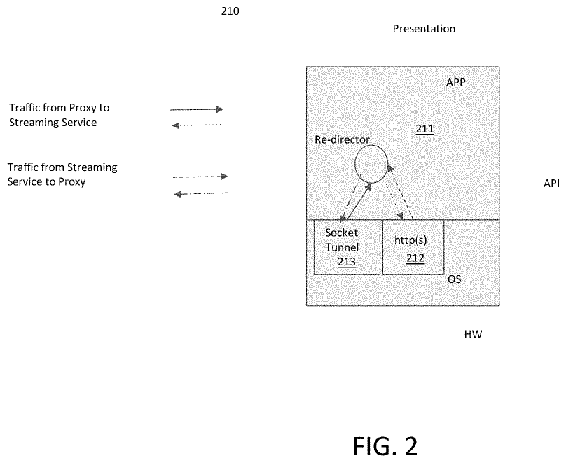

For certain applications it is a benefit to access a service provider 300 from domain of the user 200. A trivial way to do this is to instantiate a node of VPN network 400, for example VPN node 401 as an application on mobile phone 201. There are potential interactions between a user's VPN for secure Wi-Fi connections while roaming and the VPN requirements here that may make this undesirable as a solution approach. An alternative solution is shown FIG. 2. Subsystem 210 is representative of an application executing on mobile devices such as 201 and 202. Said application executes on a HW device with also comprises an operation system such as iOS or Android, or any similar. In addition to normal communications using http(s) protocol 212 these popular operating systems provide for an IP socket tunnel 213. The socket tunnel allows Proxy 109 to communicate with redirector 211. Redirector 211 will forward the contents received on the tunnel to one of the plurality of Service Providers 300 via https service 212. The browsing of the service is controlled by proxy 109, but from the perspective of 300 is being performed by 200.

Note that using both the network 400 and the embedded VPN solution 210 of FIG. 2 is possible. For example, some devices in the user population may not be capable of IP socket tunnels and so for those users a classic VPN is used at a slightly higher expense for the same functionality for those users.

### Social Graph

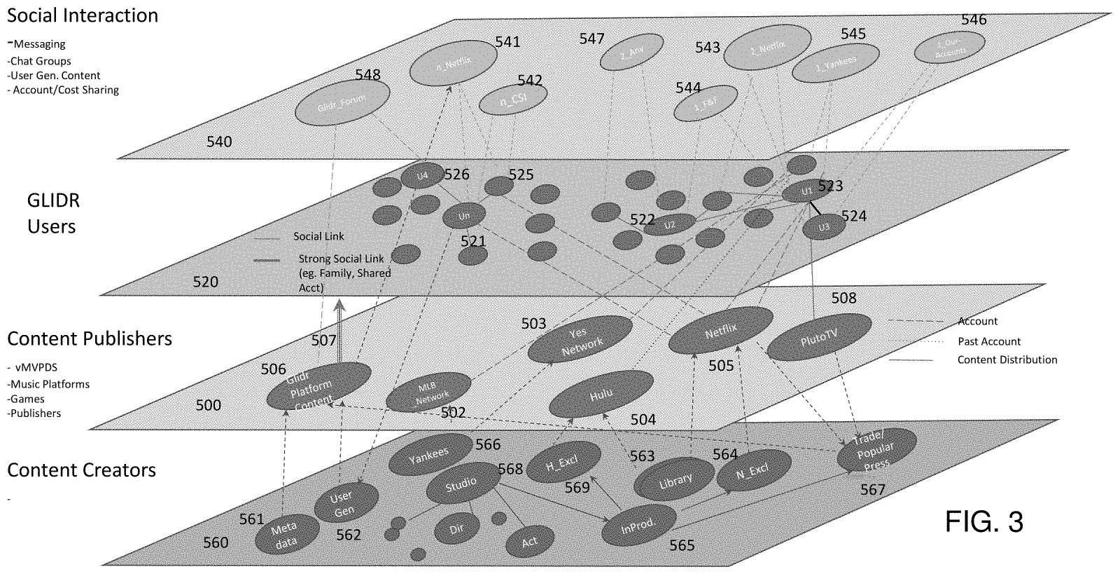

FIG. 3 illustrates the interaction of the social graph of Glidr service users and how they connect to the social features of the platform and their video services and interests. The visualization is organized in 4 planes. Plane 520 is the user space, both past and present. Plane 540 illustrates the social communication plane between users, inclusive of the optional ability of commercial entities to communicate directly to the user base.

Two-D plane 500 is a subspace populated by content sources broadly defined. This includes service providers of AVOD (Ad-supported Video On Demand), FAST (Free Ad-supported streaming TV), TVOD (Transactional Video On Demand), SVOD (Subscription Video On Demand), MVPDs (Multichannel Video Programming Distributors), vMVPDs (Virtual Multichannel Video Programming Distributors) as well as content creators such as Studios, Sport Teams and Leagues, Actors, Directors, Influencers, etc. The Glidr platform 506 is also shown in 500 where 507 represents the fact that the Glidr platform can address content to any user, group of users, or the entire population of users. Two-D plane 560 shows sources of content, inclusive of video content creation and associated information, but also related information such as content from Press and Influencers.

The social graph is representative of the user population (U1, U2 . . . Un) and linkages between users as expressed through identified “friends”. A family member or very close friend is also depicted and are party to unique attributes such using a common account for viewing content. Users U1 523 and U2 522 who share a standard “friend” status, while U1 523 and U3 524 are friends with the special attributes associated with family and strong friends. User Un 521 is another user with his/her own friends, but not closely connected to U2 522 or U1 523.

Users in the plane 520 can use the Glidr platforms chat and social functionalities to create forums to discuss various topics amongst their friends. While not a technical limitation, the expectation is that the groups formed, and topics discussed will digitally replicate those that happen in the non-digital world amongst close friends/family. This is more exclusive and intimate than those interactions on large platforms such as Facebook or quasi-anonymous interactions on Reddit. The space of multi-user social forums are shown in 540 where each element represents an interaction forum such as a Chat group. The topics of the group and scope of the discussion is entirely defined by the user creating the group. For example, 543 2_Netflix is a group, formed by U1 for the discussion of Netflix amongst friends. Similarly, the nth user has created group n_Netflix 541 to also discuss things related to Netflix amongst his/her friends who joint that group. There need not be an identified topic for creating the group, as can be seen by 547 denoted 2_Any which is meant to convey that any topic is discussed in this group created by U2 522.

Within chat groups, topics can be tracked. This might be by text string, streaming service, show, movie, or celebrity. These items can be tracked across multiple chat groups for the same or different users. The ability to track items of interest across the social plane 540 and between users 520 is a key aspect of the Glidr system.

The fundamental property about groups is that they are completely defined by the creator of the group and the topics and issues discussed within the group. Glidr has no editorial control over a group except for the Glidr_Forum 548 which is a discussion forum created by Glidr and joined by U4 526. All discussions and their content are completely at the discretion of the members, subject only to normal restrictions found in the Terms of Service to which each user agrees.

Analogous to users 520 creating dialog and content represented in the social interactions 540, Content Producers in 560 create content Published through entities in 500. The Publishers consist of the well-known general content platforms such as Netflix 505, Hulu 504, and PlutoTV 508. It also includes Regional platforms such as Yes Network 503, or narrowcaster MLB Networks 502. Games shown on traditional OTA free-TV are not shown in the diagram but are an alternative means to see some games in some markets. Glidr also functions as a Publisher 506 for content it acquires and curates for its users. The lines are blurring and for example the Yankees distribute both through contracts with 503 and 502 for full baseball games. Sports leagues are increasingly directly publishing content while also licensing content to traditional outlets.

By far the largest type of content carried by platforms dependent on internet distribution are Movies and TV Series. This content is typically exclusive to a publisher when very new and more widely licensed as it ages. Two exclusive libraries are depicted in 564 and 569, while library content is shown as 563. Content in production and not yet released 565 is sourced from Studios and independent film producers 568. Users can also generate content, and 562 represents one of many repositories. In the figure, User n (Un) 521 creates a piece of content which is uploaded to 562 and, at a later time, the same user references and shares that content with group 541 as sourced by 506.

### Service Management

The Glidr system 100 provides a robust set of features for managing streaming video services. This includes an onboarding experience, tracking of subscribed services, budgeting potential service changes, assisting the user in changing their service status and a password locker for storing and displaying service credentials. All forms of video streaming services are supported in the application: SVOD, AVOD, TVOD, FAST, and vMVPD. In addition, it would be possible to include the conventional MVPD, such as cable, satellite and telco, and OTA (Over The Air) local TV broadcaster forms of program distribution.

As the first step in using the Glidr application 200, a user must establish a Glidr account. This requires entry of a Name, Email address and Password. Optionally, a Photo image can be associated with the account, either by taking a picture from the device camera, or selecting an image from a photo library. The Email address will be verified using the typical techniques used by other applications for this purpose. Over time, the Glidr account Profile will be enhanced with all relevant user information, leading to a rich set of data for that user. This data may include, but is not limited to phone number, zip code, credit card, demographics, viewing history and wish list, favorite shows or movies, service subscription history, viewing devices, friends, cost sharing information, and application preferences or settings. Common industry security principles will be utilized for protecting this information. Account information will be stored in the database 105, or locally in the Glidr application as needed.

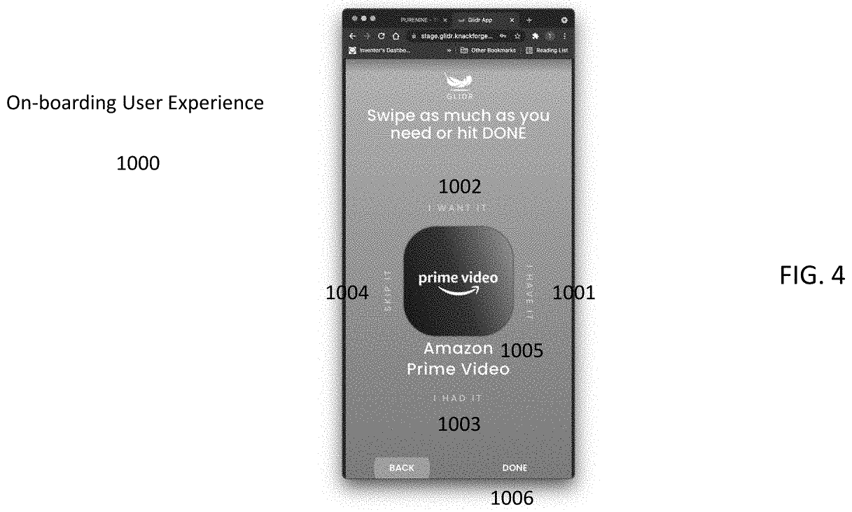

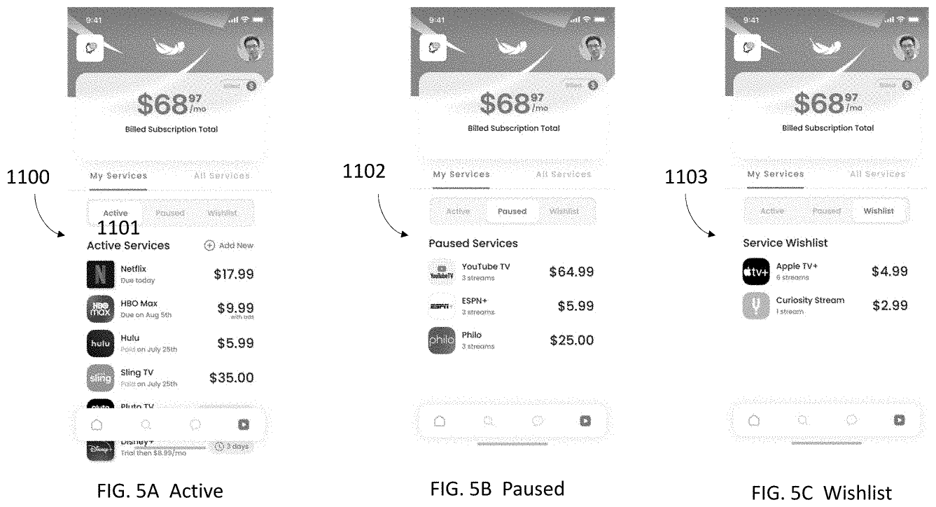

After creating an account, a one-time onboarding user experience 1000 is illustrated in FIG. 4. Initially, the user will be asked to categorize Streaming Services 1005 into one of 4 categories: 1) I have it 1001, 2) I want it 1002, 3) I had it 1003, 4) Skip it 1004. Services will be presented in order of popularity, so that the likelihood of selecting “I have it” or “I want it” will be high. The user determines the category by swiping the logo in the appropriate direction. Or the user can just touch the category (up/down/left/right). After the service is categorized, a new streaming service logo will appear on the stack. After a minimum of 5 selections, the user can continue to categorize streaming services, or press the Done button 1006 and move on to the Service Dashboard in FIG. 5. Note that the minimum number of services to be categorized can be other values and may be adjusted based on further research. From these four categories it is possible to categorize the services as: Active, Paused, or Wishlist.

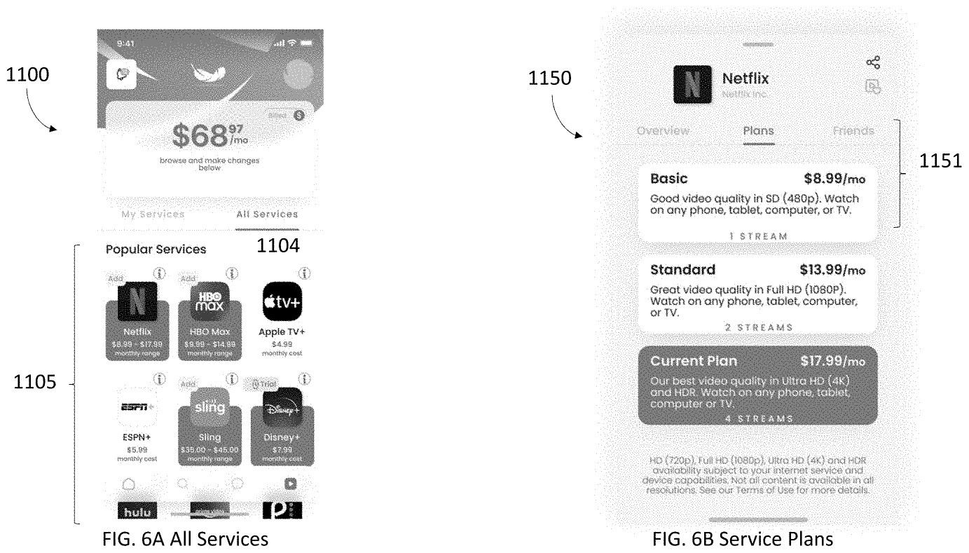

Once the onboarding experience is completed the user is presented the Service Dashboard 1100 as depicted in FIG. 5. Key attributes of this screen are monthly total cost for the subscribed services. A list of My Services, including Active 1101, Paused 1102 and Wishlist 1103 tabs can be selected. In addition, an All Services tab 1104 is shown in FIG. 6A. This is a list of all the streaming services supported by Glidr. From this screen 1104 the user can select different combinations of services (by temporarily Adding them) 1105 and determine what the total cost would be for the selected services. This allows the user to explore different budget scenarios. Further, specific details about a streaming service 1150 and the plans that are offered 1151 is shown in FIG. 6B. Users can select the service plan that fits their needs and reflect that in the budgeting exercise.

Various actions can be performed on any of the listed services. This includes adding streaming service login credentials (Username and Password), adjusting the service level for the correct plan, and entering the monthly billing date. Once the login credentials are entered and stored in a Password Locker 112, the Glidr application can use the User Proxy 109 as described above to have Glidr automatically update these same items.

The user can also initiate, or track, service changes such as pausing an Active service, or cancelling a service entirely. Paused services can also be reinstated to Active status or cancelled. For Any service change, the monthly total cost will be adjusted accordingly. More information can be presented about a service by pressing the logo. This is illustrated in the Streaming Service Details screen 1600. This information can include access to the Password Locker, a service description, or popular content currently playing on a service. Direct linkage to the service player application on the same device will also be provided.

For any service changes that require an adjustment of the streaming service status, Glidr will provide a full set of directions and service screen page links (deep links) to assist the user in making the changes. If these changes can be made using the User Proxy 109, the user will be asked if they wish to have Glidr perform the action. If they select this option, confirmation will be proved regarding success, or not, and the updated service status will be display on the Service Dashboard.

Once the user has entered their streaming service login credentials, the Glidr application will use the User Proxy 109 to collect the viewing history and content watchlist from each service provider. This information will be collected on a periodic basis as need to support Glidr features. Each streaming service user profile will be tracked separately. In addition, Glidr will collect viewing activity from any viewing device that can share that information with Glidr. This may be implemented by ACR (Automatic Content Recognition) technology, or other fingerprinting or watermarking technology.

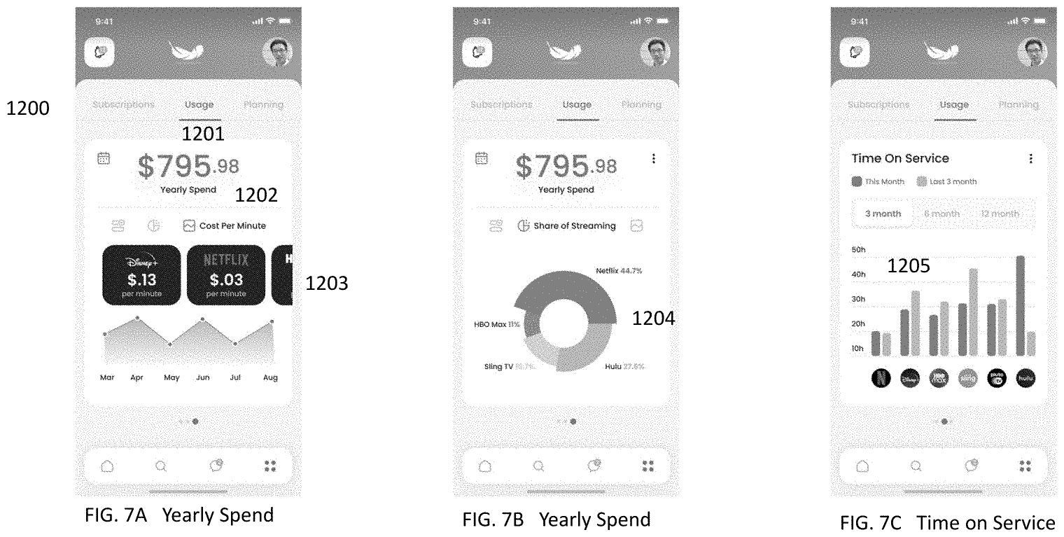

Statistics regarding the user's subscribed services are depicted in FIG. 7. A user statistics screen 1200 has various types of information that can be presented. Several examples of streaming service Usage 1201 are presented. In FIG. 7A, the total yearly spend 1202 for all streaming services is presented in a line chart calculated on a monthly basis. In addition, the costs per minute 1203 for each service is shown. In FIG. 7B, the share of the time spent streaming each service 1204 is illustrated in a modified pie chart format. In FIG. 7C, the time spent viewing each service 1205 is shown as a bar chart over various time spans. Other useful statistics can also be shown but not illustrated in these examples.

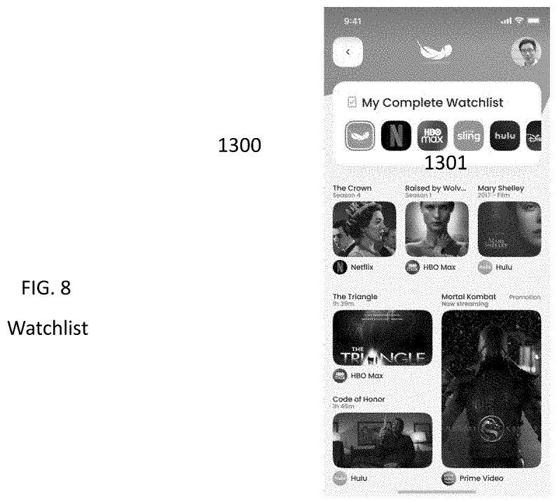

Glidr will aggregate Watchlists from each streaming service into one Glidr Watchlist 1300. This is illustrated in FIG. 8. In addition, items can be added to the Watchlist from other Glidr features such as Search and Social recommendations. Filtering of the Watchlist by streaming service provider 1301 or other criteria will be provided. Notifications will be provided to the user when Watchlist items are going to be available for viewing. As described elsewhere in this specification, Watchlists can be shared with friends and family. Further, a recommendation list can be added based on suggestions from friends and family. A universal watchlist combines watchlists from multiple streaming services and exposes those watchlists in aggregated form allowing a user to compare and contrast what and how much content they might want to watch from each streaming service.

By presenting a universal watchlist to the user, this gives the user an overall understanding of what and how much they might want to watch on one service versus another so that they can make informed decisions on which service they might want to subscribe to (and when) versus other services and for how long. A universal watchlist will also help users prioritize what content they want to watch (and when) and what services they want to subscribe to (and when) and therefore help users manage and optimize their budget.

Free streaming service trial management is a special feature of the Glidr system 100. Users may not be aware of the terms of a free trial, is it one or two weeks or even a month? If a user signs up for a free trial, when do they need to cancel to prevent entering into a monthly subscription status? The system will track and provide notifications when a free trial is ending. Further, the system will notify your friends and family that you have a free trial underway, in case they want to join you. If you decide to continue with a subscription, the users My Services Active list will be updated along with a corresponding increase in the total monthly cost tracking. If the user decides to cancel, the system will assist them in completing that transaction. If appropriate, the streaming service will be added to the My Services Wishlist.

As another Glidr feature, Parental Controls can be managed for streaming service providers that support such account or user functionality. With this feature a consistent set of controls can be configured across all the user's streaming services. To augment the user profile data described above, it will also be possible to present surveys to Glidr users. These surveys may be done within the Glidr application, or via other means such as text messages or email. Surveys may be implemented in support of new Glidr features, or merely to improve the user profile. Possible survey questions include but are not limited to the following: current video services; must have shows, movies or channels; sports and sports teams; monthly budget; tolerance to advertising; available viewing time for the month; or viewing equipment.

### Budget Optimization

Several approaches can be considered for optimizing the satisfaction of the user when considering a budget for the amount of money spent to subscribe to streaming services. Glidr can make recommendations for subscriptions and a user can decide on which services to subscribe to based on for example, their past viewing behavior, frequency of use, length of use, favorite shows, or movies, required channels, and the cost of the services. Glidr would not only consider the user's preferences in making a recommendation, but the system could also take into account and expose the user to data from their social connections including, for example, what their social connections subscribe to, have watched, want to watch, and have recommended.

By including this data from their social connections in budget optimization, Glidr can help further optimize the user's budget across services by, for example, giving higher weight to friends' recommendations, similar viewing patterns, or similar or common content that they want, propensity to share services and make a recommendation that will give the user higher satisfaction and possibly reduce the likelihood they will churn out of a service.

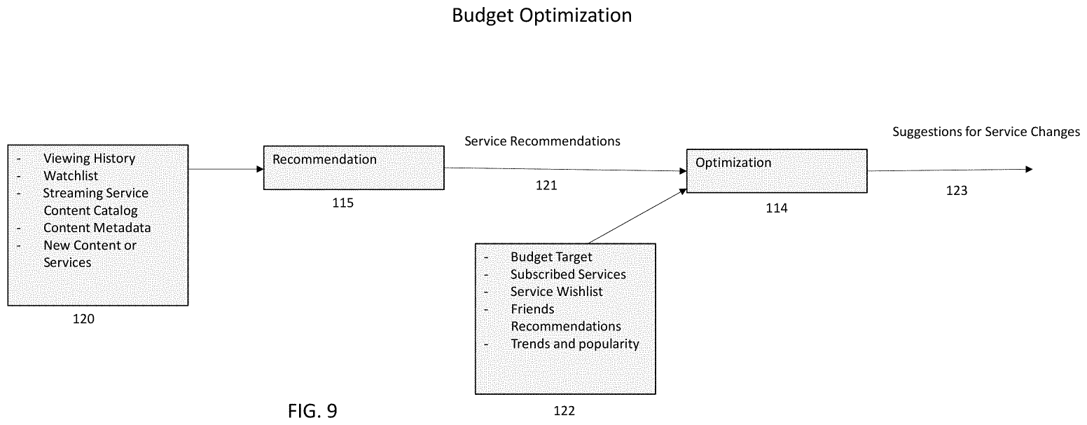

A first budget optimization process is illustrated in FIG. 9. The goal of this process is to provide recommendations to the user on streaming service changes that will provide a better viewing experience when constrained by a budget for the monthly total cost that the user is willing to spend. This continuous optimization process is one of the key features of the Glidr system. Typically, this process will be performed on a monthly basis, although other time frames are possible. For example, it could be run every time that one of the user's current streaming service subscriptions nears its monthly renewal (billing) date.

As shown in FIG. 9 there is an optimization engine 114 working in conjunction with a recommendation engine 115. There are companies that provide video content recommendation engines, such as Think Analytics and TiVo (Xperi). However, there is no engine that provides streaming service recommendations based on a continuous evaluation of a user's profile (or a group level profile). This is the purpose of the recommendation 115 and optimization 114 engines. Glidr will utilize content and service recommendations along with other factors and optimize against a monthly budget target provided by the user.

Service recommendations from engine 115 are based on a number of inputs 120 including but not limited to: the availability of content across the various streaming services, both the current and future catalogs; the users' viewing history; the user's watchlist; new content or services; and content metadata. The output of the recommendation engine 115 is one or more service recommendations 121. The service recommendations 121 are presented as a prioritized list with a service viewing factor. The service viewing factor is based on an arbitrary scale, but it represents the quality of the recommendation for that service as it pertains to the user's profile. Note that the user profile can be a single profile, a family profile, or even a profile that is based on a collection of the user's friends or family. The service recommendations are derived from the inputs 120 as optimized by a recommendation algorithm. This recommendation algorithm is different from the conventional video content recommendation algorithm because it rolls video content recommendations up into service recommendations.

While there are numerous optimization techniques available to satisfy the problem, the Glidr service exploits the inherent constrained set of outcomes (e.g., the number of streaming services) and is therefore a more efficient and unique approach. Currently, there are 300+ such services, but the majority of viewing is done within the top 30-50 services. Techniques to implement the recommendation engine 115 include simple weighted formulas, collaborative filtering, similar content matching, any number of optimization algorithms (such as bound constrained optimization, linear programming, quadratic programming, nonlinear programming, or semi-infinite programming each of which has various well-known methods for implementation) or a hybrid of any of these techniques. Artificial Intelligence (AI) systems can also be trained from the Glidr profile as well as inputs 120 and used as another technique.

The service recommendations 121 and other inputs 122 are then fed into an optimization engine 114. The other inputs 122 include but are not limited to: a monthly streaming service total cost budget target; the user's subscribed streaming services; the users Wishlist of services; friends' recommendations; and trends and popularity of shows and their corresponding services. The optimization 114 engine will compare the service recommendations 121 against the inputs 122 to generate optimized suggestions for service changes 123. The optimization techniques used by the optimization engine 114, may be similar to what is used for the recommendation engine 115. As part of the process, a service viewing factor will also be calculated for the subscribed services, the services Wishlist and friends' recommendations. This will be a key factor in determining if service changes are recommended. Each input will be weighted as to its importance, with friends' recommendations rated higher than some of the other inputs based on the strong influence that they exhibit.

A second optimization enablement provides further examples of how the recommendation 115 and optimization 114 engines may be implemented. Users 520 face the dilemma of where to spend their entertainment dollars to access content via free, subscription, ownership, or rental licenses. The interconnection of Content sources, users with their likes and dislikes, and their social connections and interactions all are in digital form and can be processed by subsystems in Glidr Platform 100 for the purpose of algorithmically determining what sources of content meet a user's content and budget needs. Ideally, a user can access sufficient content of the type they prefer while not exceeding a level of spending that they are comfortable with. Content publishers can be characterized for the optimization purpose by the following non exhaustive list:

Content catalog
Content price terms (AVOD, SVOD, Subscription)
Distribution networks (Internet, Cable, Satellite)
Hardware required (Set top box, decoding device, compatibility with mobile phone)
User restrictions (number of devices and simultaneous users, geographic blackout, etc.)
Language options
User Experience

Users can be characterized by the following non exhaustive list:
Demographics
Friend and Family connections
Stated Preferences (likes, dislikes, disinterests)
Subscriptions
Subscription History
Watch History
Watchlist
Social Group membership
Social interaction and reactions (Chat logs, comments, likes, dislikes, sentiments expressed, etc.)
Information consumed
Influencers followed.
Level of engagement

The approach as described below is to recast objective measures of an individual metric as a normalized number between 0 and 1 and then consider weighted combinations of 1 or more when used within subsequent functions, where the weights are used to increase the contribution of one variable as compared to another variable. An example of variables that have this normalized property include but are not limited to the following:
Probabilities: Prob(x=X) for discrete events or Prob(x<X) for continuous variables
Indicator functions: I(x)=1 if “x” is true and 0 if “x” is not true.
Ratios to the maximum: y=|x|/Max(|X|)
Normalized counts of an event: Number of all True events/Number of All events.
Nonlinear transformations what preserve the range of the output to be the range of the input: e.g.: y=x*x when 0<x<1
100×% of content watched on a given service.
100×% of persons in a distance weighted social network are satisfied with a network.

Not all information available to the algorithm is numeric. For example, the user may state preferences such as “likes Westerns” as a genre, or the user cancelled Disney+ in the past. The Glidr service provides the user with recommendations for which service to use when consuming information and entertainment that are the “best” mix of services on which to spend their resources of money and time. Any optimization requires a performance index. For this we use Satisfaction subject to the constraint in cost less than or equal to a fixed budget. If it is given a choice of adding 1 or N services that fit within the constraint, we add the one with the highest probability of satisfaction. If to meet the cost constraint a service must be deleted, then we will add the services with the highest probability greater than the satisfaction score of the service being dropped. Data, even numeric and amenable to computation may be sparse.

A useful estimation method for sparse data and non-numeric information is to use Bayesian Inference (BI). BI is a hypothesis testing method whereby a priori probabilities (the “priors”) are updated based on observed data. So, the metric we will be calculating is:

P(θ|D)=(P(D|θ)×P(θ))/P(D)

where the computation of interest is to compute the probability of satisfaction given subscription status P(θ|D). The priors on P(θ) and P(D) can be estimated from data within the Glidr maintained Social/Content network depicted in FIG. 3. The conditioning data can also be quite complex. For example, if θ relates to “is Satisfied”, D can is a statement about subscription status. Trivially it is “is Subscribed to Service X” where X is any service within the Content plane 500. As an example, consider X equals “Curiosity Stream”. Based on the actual characteristics of the user, an alternative D statement could be “is Subscribed to Curiosity Stream AND is Males the ages of 25-29 yrs. old”. The Glidr platform builds and maintains Probability Density functions for all relevant Priors and then can draw a Bayesian Inference for each recommendation choice, then present to the user the one with the highest probability. When data are lacking, empirically derived Priors can be replaced with idealized statistical models. Two common models are used, being “equally likely” or “normally distributed” in which case the output corresponds to a Maximal Likelihood (ML) or Maximum A Posteriori (MAP) prediction respectively. Furthermore, the system computes a multiplicity of estimates with different conditionals and uses a weighted combination for final determination. Examples of alternative Priors include but are not limited to “people closely linked in the social graph”, “people who follow a common Influencer”, “people who express interest in a Genre I like”, etc. One key aspect of the problem is the time evolution of both the content landscape and a user's interests. Future content pre-release is represented by reviews coming from the press and past satisfaction based on content judged to evoke a similar and correlated response.

An example of weighted combinations above would be to consider the three different observed data in the proceeding, namely D1 is “people closely linked in the social graph”, D2 is “people who follow a common Influencer”, and D3 is “people who express interest in a Genre I like”. Each Bayesian estimate is computed as P(θ|Di) and combined estimate finding the Maximum of:

P=w1*P(θ|D1)+w2*P(θ|D2)+w3*P(θ|D3)

where the w1, w2 and w3 are heuristically determined weights between 0 and 1. The function P can be multimodal, that is having local maximum and minimum values. Optimization where the function has a single extremum is well known and efficient algorithms such as “steepest descents” algorithms can be used. In the case where there are multidimensional, or multimodal, then other suboptimal but computationally efficient algorithms such as simulated annealing, particle swarm or hybrid combinations are known in the literature and are applied in some cases. What is unique is the selection of observable data sets extracted from FIG. 3 and their application to the performance index regardless of computational method.

The cost constraint is a classic knapsack problem of determining what items of varying measure (weight or in this case cost) are combined to reach a total measure (in this case total cost). If there are N items, there are 2″ subsets that can be examined for total cost and to the one with the maximum probability of satisfaction is the optimum constrained recommendation. As the number of services grows large, optimum solutions become unreasonably complex. Suboptimal algorithms are well known in the literature, such as “greedy algorithm”, “backtracking algorithms”, and other well-known dynamic programming algorithms. Computationally acceptable solutions will vary for different ranges of N, including optimal exhaustive search for small N, or a highly tuned dynamic programming using multiple programming methods based on heuristics.

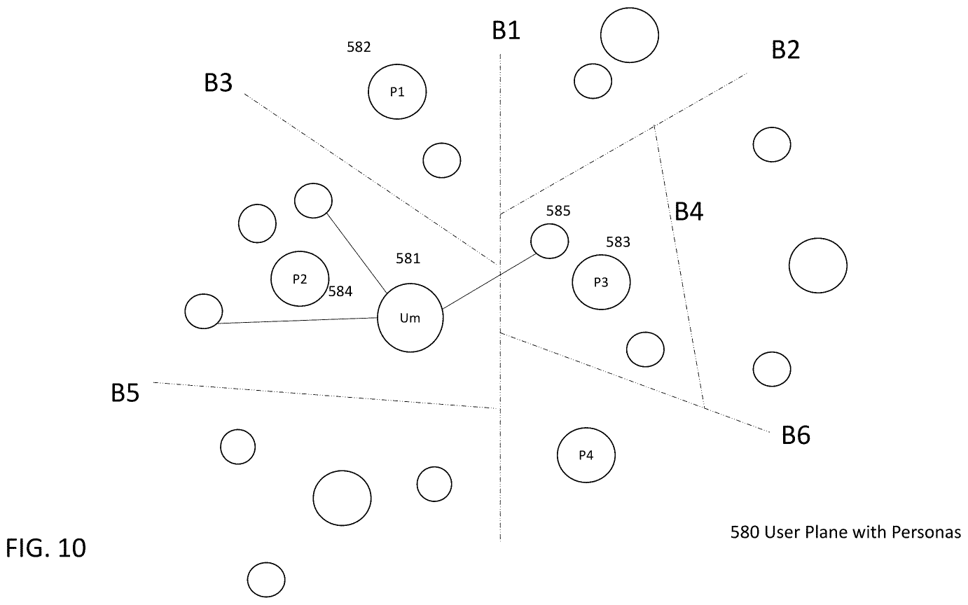

One can recognize that the computational complexity of the problem motivates using techniques with lower computational requirements that may not yield as optimal statistical results. What is optimized is not the errors in the recommendations, but also in light of computational requirements. This section describes one such simplification. In addition to real unique users of the Glidr platform 540, this mode of operation defines a set of pseudo users who are aligned with attributes of real users. FIG. 10 shows such a configuration. Each user, such as Um 581 is one of the users in plane 560. They have all the attributes of any other users, including friends, chat group membership, etc. Also 581, 582 and 583 are personas which are instantiated for computational efficiency. They are chosen to reflect a diverse set of attributes consistent with the desires of real users. The simplest example would be to consider 16 personas corresponding to Male and Female with age rates of 10-19. 20-29. 30-39. 40-49. 50-59, 60-69. 70-79, 80 & above. When preferences from real users are provided, that information is applied to the corresponding Persona. Further non-age-related segmentation can be applied such as “Netflix subscriber”, “Sports fan”, “Independent Film fan”, etc. Each real user in the plane 520 is associated with a particular Persona, and the system recommends to the user the same services as it would recommend to the Persona. As more is learned about the user, they may be assigned to a new Persona and hence get new recommendations. Maintaining server Personas is still significantly less computation that determining recommendations for a user population in the millions. Personas can be modelled to belonging to chat groups associated with users in plane 540 and to follow influencers in plane 560. The system can merge, and split Personas as required.

FIG. 10 shows a collection of users and Personas, some are connected to each other through the social graph. The plane is tessellated into regions by Voronoi boundaries B1, B2, B3 and so on and at the centroid of each region is a Persona Pi. This is analogous to the field of Vector Quantization which is well studied in the field of Image and Speech compression. The Persona has a set of attributes completely analogous to those of a user and the users located in the region are users whose performance index is maximized by having the same service subscriptions as the persona. So, when the persona representing the typical user in the region is given a revised recommendation, the users within the region are assigned the same recommendation. Users may not be immediately presented with the updated recommendations, but candidate recommendations can be predetermined by updates to the associated persona's profile. A way to assign a user to the region is to assign them to the region where PAD) is maximum for the Di representing the data associated with persona Pi. It is recognized that the 2-D plane used for illustrative purposes can be a multidimensional space in practice. Boundaries are planes and hyperplanes in some k-space where there are 2^{k} personas. Regions can be subdivided by bifurcating into 2 regions each with a persona located at the new centroids of the respective regions. The regions need not be based purely on subscriptions, but also on likes and dislikes. For example, if a region corresponded to users who had 5 subscriptions in common, but ⅓ of the users like westerns and ⅔ of the users disliked westerns it may be advantages for the system to create 2 personas that differ in this regard so future changes to content offers differentiated with respect to western content can be discriminated. A system consisting of millions of users and thousands of personas is typical.

Efficient mechanism for using computationally efficient tree searches are well known. An added improvement is to create a set of personas {Q1, Q2, . . . QL} where L is larger than K, the number of personas {P1, P2, . . . PK}. The L personas organized as a tree can be searched in Log₂ L time while the Ps are searched in K time. If Log₂ L<K then each Qi can be mapped to the closest Pk for every i. As an example, if K=1024 and L=16,384 then the best Q can be found in 10 steps and on average 8 of the Q's will correspond to 1 P. So, finding the best P can be achieved in 10 steps instead of an exhaustive search through 1024 personas, a 100-fold improvement.

Determining the optimum estimate requires evaluating the function P(θ|D)=(P(D|θ)×P(θ))/P(D) and determining the θ which maximizes the function. To do this requires that P(D|θ) P(θ) and P(D) are known. Empirically derived functions are determined as follows: For a given hypothesis θ perform the following:
Determine the segmentation criteria D. (e.g. “User subscribes to Netflix) then
Process the data within the user profiles and social networks for which D is true and create histograms P(D|θ), P(θ), and P(D) denoted D(x), θ(x) and P(x|θ).
If required create an idealized versions D′(x), θ′(x) and P′(x|θ) where for example the ideal histogram is a mathematical function chosen for accuracy or ease of implementation.

For example D(x) may have a Normal Distribution. The computation may use any of a number of available implementations, for example the well-known Python library Statistics.py. The distributions are stored in database 105 and are available for calculation of recommendations for either users or persona. Keeping distributions up to date and accurate need not be done in real time and can be a background task done once per day, every 3 days or once per week, etc. The optimization is then:
For User, or Persona, compute for each candidate new service Z, determine D for this user and service Z.
Retrieve the associated distributions.
Determine the θ that maximizes P(θ|D)=(P(D|θ)×P(θ))/P(D)
If P(θ|D) is larger than P(θ|D AND not Z), and budget target is met then recommend service Z to User or Users connected to Persona.

Explicit calculation of the Bayesian estimate is not required, but instead the social network can be used to generate training data for Deep Learning/Machine Learning AI. A DL/ML system does not use explicit probabilities, but rather rely on training sets that have statistically relevant frequencies for input vectors. Proprietary training sets using data from the social network in FIG. 3 are used for training the DL/ML system.

### Discovery

The Glidr system 100 provides a robust set of discovery features for managing streaming video services. This includes searching for shows, movies and celebrities. In addition, streaming services can be searched based on name or other characteristics. Examples of other characteristics are content (shows and movies), brand, cost, genre, original programming, film libraries, live TV, devices, etc.

### Glidr Metadata Management System

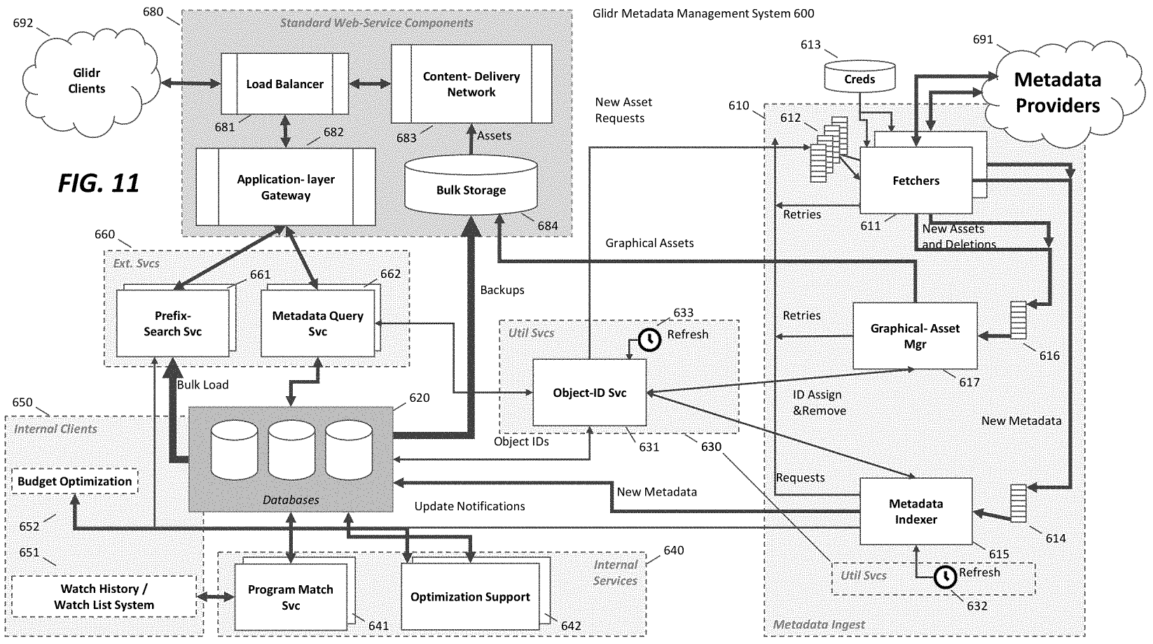

The Glidr Metadata Management System is a system within the Glidr Platform. A good and useful implementation is as a set of functionalities in a microservices architecture within the framework of FIG. 1. As such, each function and capability taught can be implemented in any functional block without a loss of generality or limiting the system. For example, Databases 620 in FIG. 11 may be considered a part of the database 105. The functional description and associated figure recreate those functional elements required for clarity in the description and are not proscriptive with respect to the architecture of the complete Glidr platform.

The Glidr Metadata Management System obtains, validates, indexes, stores, updates, and provides access to all the metadata used by Glidr. Metadata comprises all the information about content Glidr customers might view, and is understood to include at least the following types of information:
Program metadata is descriptive information about any type of audiovisual content, including, but not limited to, movies, series and their seasons and episodes, sports events and non-events, live broadcasts and streams, and any other content typically labeled “programming.”
Availability metadata describes how, when, where, and under what circumstances viewers can consume programming.
Celebrity metadata is descriptive information about an individual person, animal, or mechanism (such as a puppet or robot)—or any specific group, team, league, or other distinct organization composed in whole or in part of any combination of the aforementioned individual elements—that in some way contributes to the creation of programming.
Graphical assets are individual items of still or motion imagery—such as photographs, portraits, stills, posters, logos, artwork, clips, trailers, or commentary—that accompany or are associated with, but not directly part of, a piece of content. In some circumstances these graphical assets can themselves be considered content and thus have their own associated metadata.

Glidr can obtain metadata in a variety of ways, including through arrangements with Metadata Providers or individual metadata creators, directly from content creators or distributors, through crowdsourcing, and from Glidr's own customers. Each source of metadata may impose unique requirements or constraints on the retention and use of that metadata; the Glidr Metadata Management System must include means to ensure compliance with these requirements and constraints.

FIG. 11 shows the major subsystems of the Glidr Metadata Management System, along with other systems with which they communicate:
Metadata Ingest 610 obtains, validates, and indexes metadata for storage by the system.
Databases 620 and Bulk Storage 684 store the metadata for use by the system.
Utility Services 630 provide specific functions used by other components within the Glidr Metadata Management System.
Internal Services 640 expose specific functions for use by other Glidr systems.
Internal Clients 650 represent other Glidr systems that use the Internal Services but are not part of the Glidr Metadata Management System.
External Services 660 expose specific functions for use by clients external to Glidr.
Standard Web-Service Components 680 are familiar system components used by many online services to satisfy non-functional requirements such as availability, scalability, and security.
Glidr Clients 692 represents that portion of the functionality of Glidr Clients 200 that communicates with the Glidr Metadata Management System.

The larger shaded boxes in FIG. 11 represent certain of these subsystems, while the smaller unshaded boxes represent individual system components. Various embodiments of these individual system components are possible; for example, they could be embodied as subroutines or threads of execution in a larger program, as independently running programs on the same or different host processors, or as dedicated hardware. Further, any single system component—other than a Fetcher 611—in the diagram could be embodied as a plurality of identical components to meet specific non-functional requirements such as performance, scalability, reliability, or maintainability. Fetcher scalability has special requirements described under Metadata Ingest 610 below.

The connectors in the diagram represent the communication of specific types of information between distinct system components. The arrowheads indicate the primary, but not necessarily the only, direction of information flow. Bidirectional connectors indicate an approximately balanced flow. The thickness of the lines is intended to communicate a qualitative impression of the volume of information flow but is not to scale.

Various embodiments of these communication functions are possible, depending in part on the location and nature of the subsystems communicating. For example, embodiments could include, but are not limited to, procedure calls, shared-memory techniques, operating-system interprocess communication facilities, and network communications over virtual connections or physical electrical, optical, or wireless links.

### Metadata Ingest

Metadata Ingest 610 (also shown as 113) obtains, validates, and indexes metadata for storage.

Metadata Providers 691, organizations that create and/or aggregate metadata and make it available through a unified interface, are an important source of metadata. Metadata Providers exist outside the Glidr Metadata Management System, and thus said System must arrange communications with said Providers. For example, said System may communicate with a Metadata Provider over the open Internet.

Each Metadata Provider specifies the interface Glidr must use to obtain the metadata and may specify certain constraints on that use. For example, a Metadata Provider may limit the number and size of metadata requests Glidr may make during a defined period or interval. A Metadata Provider may also require the Glidr Metadata Management System to authenticate itself during some or all of the requests it makes. For example, said System may be required to present credentials in the form of one or more secret passwords or tokens, satisfy an authentication challenge, or perform any of a variety of other authentication tasks specified by the Metadata Provider.

Separately, a Metadata Provider may impose certain requirements or constraints on Glidr's retention and use of the metadata once it has been obtained. For example, a Metadata Provider might limit the use of certain metadata items or portions of metadata items to specific purposes. As another example, a Metadata Provider might require that certain metadata items be retained for no longer than a specified time interval, or until some unspecified future time at which the Metadata Provider requires the item be removed.

### Fetchers, Request Queues, and Credentials

Each Fetcher 611 mediates communication with a specific Metadata Provider 691. The Fetcher is responsible for performing any required authentication tasks and for ensuring adherence to all constraints on the use of the interface provided by the Metadata Provider. The Fetcher is also responsible for performing any necessary transformations of the received metadata from the representations delivered by the Metadata Provider into representations suited to the needs of the Glidr Metadata Management System.

Each Fetcher is thus specialized to the particular Metadata Provider with which it communicates. In one embodiment, a Fetcher is specifically coded to implement this communication. In a second embodiment, a generic Fetcher implementation is specialized by external configuration information. In a third embodiment, a combination of the preceding approaches is used. A plurality of Fetcher embodiments may coexist in a single instance of the Glidr Metadata Management System.

Nevertheless, adherence to constraints on the use of the interface provided by the Metadata Provider imposes special requirements on how a Fetcher can be scaled to provide, for example, increased capacity or robustness. In particular, an embodiment that includes a plurality of threads, processes, or other system components communicating with a single Metadata Provider requires some means to ensure that the combined activity of all the components remains within said constraints. In one embodiment, said components all communicate with a single coordinating entity that enforces adherence to said constraints.

The processing performed by each Fetcher is determined by metadata requests arriving from various components of the Glidr Metadata Management System; in response to a metadata request, the Fetcher attempts to obtain the requested metadata from the Metadata Provider with which it communicates. Because adherence to certain usage constraints imposed by a Metadata Provider may temporarily cause the Fetcher to process metadata requests more slowly than they arrive, incoming requests wait in a Request Queue 612 until they can be processed.

In one embodiment, a single Request Queue serves all Fetcher instances. In another embodiment, each Fetcher instance drains a separate Request Queue. The Request Queue itself is a virtual construct; internally it may be embodied as a single queue of metadata requests, or as a plurality of queues, each holding metadata requests with specific properties.

In one embodiment, metadata requests are processed in the order received; in another embodiment, metadata requests may have an associated priority that dictates the order in which said requests will be processed. This latter embodiment allows faster processing of time-critical metadata requests and reduces the negative impact of interface usage constraints imposed by the Metadata Provider on the speed of processing of said requests.

Similarly, in one embodiment, all metadata requests are considered immediately eligible for processing; in another embodiment, metadata requests may include an indication of the earliest date and time at which they may be processed. This latter embodiment simplifies the implementation of request scheduling throughout the Glidr Metadata Management System, and in particular the scheduling of retries of metadata requests that failed because of temporary problems either within or outside the Glidr Metadata Management System.

To perform authentication tasks required by the Metadata Provider with which it communicates, a Fetcher may require access to credentials that should otherwise be kept secret. Said credentials are thus kept in a Credential Store 613. In the preferred embodiment, this Credential Store is entirely separate from the Password Locker 112 used to store customers' credentials, and accessible only to Fetcher instances that require those Metadata Provider authentication credentials.

Similarly, in the preferred embodiment some degree of isolation exists between the Fetcher instances and the remainder of the Glidr Metadata Management System, both to limit exposure of the authentication credentials to said remainder and to protect said remainder from any connections to the open Internet the Fetchers may maintain.

Finally, one or more development and/or test instances of the entire Glidr Metadata Management System may exist in parallel with the instances used in production. Because Metadata Providers often do not provide separate credentials for development or testing, these various instances require some means to ensure their combined activities adhere to the constraints imposed by the Metadata Providers. In one embodiment, the same set of Fetchers serve all the instances of said System; the metadata requests include additional information identifying the System instance that originated each request and to which any responses should be returned. In a second embodiment, separate Fetcher instances exist in each System instance, but there exist means to ensure that the combined activity of all the Fetchers remains within said constraints. In one embodiment, said Fetchers all communicate with a single coordinating entity that enforces adherence to said constraints.

Any means to coordinate access to a single Metadata Provider by multiple instances of the Glidr Metadata Management System may also assign each instance a different interpretation of any processing priorities specified by metadata requests originated by that instance. For example, said means may treat a High Priority request from a test instance as having lower priority than a High Priority request from a production instance, but higher priority than a Routine Priority request from said production instance.

### Metadata Response Processing

A metadata request processed by a Fetcher can succeed or fail. If it succeeds, the Fetcher will process the result into a metadata response and forward said response to either the Textual-Metadata Response Queue 614 or the Graphical-Asset Response Queue 616, according to its nature.

If the request fails, and the responsible Fetcher determines that the reason for failure is a temporary problem—for example, a network connection, server, or other required resource is temporarily unavailable—the Fetcher will resubmit the failed request to said Fetcher's own Request Queue. In one embodiment, the Fetcher will delay for some interval before resubmitting said request. In another embodiment, the Fetcher will modify said request to specify a specific future time at or after which said request can be processed. In either embodiment, resubmitted requests may include some indication of how long the request has been delayed and/or how many times the request has been resubmitted.

When resubmitting a request after a subsequent failure, the Fetcher may also increase the imposed delay according to some algorithm. For example, it could implement the bounded binary exponential backoff algorithm, which doubles the delay after each failure, up to some specified maximum delay.

If the Fetcher determines that the reason a particular metadata request has failed is a permanent problem—for example, said request is ill-formed or refers to metadata that does not exist—or that a seemingly valid request has experienced too many successive failures, it will discard said request and return a failure response to the originator of said request.

### Textual-Metadata Processing

The Metadata Indexer 615 reads responses from the Textual-Metadata Response Queue 614. Metadata items contained in the responses have identifiers assigned by the Metadata Provider from which they were obtained. The Metadata Indexer sends each such identifier to the Object-ID Service 631, which either retrieves the unique identifier Glidr previously assigned to the metadata item or assigns a new unique identifier if none was previously assigned. The mappings between identifiers assigned by Metadata Providers and those assigned by Glidr are maintained in one of the Metadata Databases 620. The Metadata Indexer then adds or replaces said metadata item in another of the Metadata Databases using said Glidr unique identifier as the primary key for said metadata item.

In addition, said database includes means to perform full-text indexing of various fields such as names, descriptions, and keywords in said metadata item. The Internal Services 640 and External Services 660 use the indices thus created to find metadata items of interest. Some Metadata Providers do not provide any notification that new or modified metadata items are available for retrieval. Thus, from time to time the Metadata Refresh Timer 632 instructs the Metadata Indexer to create and forward a metadata request that in turn instructs one or more Fetchers 611 to negotiate with the interfaces provided by their associated Metadata Providers to begin the retrieval of new or modified metadata items. Said request may be for metadata items of any specific textual-metadata variety or plurality of varieties. These items will subsequently begin arriving in the Textual-Metadata Response Queue 614 for indexing.

Said request is typically made at Routine Priority so that higher-priority requests can take precedence. Because processing said request may cause the retrieval of thousands or even millions of metadata items from a single Metadata Provider, a means must be provided to limit the number of items retrieved in any operation that cannot be interrupted. In one embodiment, after negotiating with a Metadata Provider's interface to determine the approximate number of new or modified metadata items to be retrieved, the associated Fetcher will replace the original metadata request on the Request Queue 612 with a plurality of requests, each for a different subset of the metadata available to be retrieved. Said Fetcher can then process these smaller requests atomically without significantly delaying any higher-priority requests that arrive in the interim. The Metadata Indexer does not request retrieval of graphical assets.

### Graphical-Asset Processing

The Graphical-Asset Manager 617 reads responses from the Graphical-Asset Response Queue 616. Similarly to the operation of the Metadata Indexer 615, the Graphical-Asset Manager contacts the Object-ID Service 631 to receive a Glidr-specific unique identifier for each received asset. In one embodiment, the Graphical-Asset Manager then stores said asset under said unique identifier, and a Glidr Client 692 that wishes to display said asset must refer to it by said unique identifier. In a second embodiment, the Metadata Provider will arrange to serve said asset directly to clients, in which case the Glidr Client must refer to said asset by the identifier originally assigned by the Metadata Provider. In a third embodiment, the Metadata Provider will arrange to serve certain classes of graphical assets—for example motion imagery—directly while requiring Glidr to serve other classes—for example still images—directly.

In embodiments where Glidr must serve at least some of the graphical assets, the Graphical-Asset Manager will arrange to make said assets available for efficient, scalable delivery to Glidr Clients. For example, graphical assets can be made available by staging them to a Content-Delivery Network 683 (CDN), a standard means to distribute primarily static content on the open Internet. In one embodiment, the CDN is a part of the Glidr Metadata Management System. In another embodiment, a commercial CDN operated by a third party is used. In either embodiment, the Graphical-Asset Manager will stage the graphical assets to Bulk Storage 684 (also shown as 104) for distribution throughout the CDN.

Metadata Providers typically make available a multitude of graphical assets. Because of the number and bulk of these assets, the Glidr Metadata Management System does not attempt to retrieve all the assets available. Instead, it retrieves only those assets specifically requested by a Glidr Client 692 or deemed likely to be so requested. One reason a graphical asset might be deemed likely to be requested is that said asset is associated with content known to be of current or ongoing popularity. Content-popularity information is available from some Metadata Providers as well as other well-known sources.

A Metadata Provider may impose certain requirements or constraints on Glidr's retention and use of graphical assets once they have been obtained. For example, a Metadata Provider might require that said assets be retained for no longer than a specified time interval, or until some unspecified future time at which the Metadata Provider requires the item be removed.

The Fetchers 611 maintain all information about the specific requirements or constraints their associated Metadata Providers impose, but the Object-ID Service 631 tracks the graphical assets they obtain; thus, both subsystems must be involved in implementing said requirements or constraints. The Graphical-Asset Refresh Timer 633 periodically instructs the Object-ID Service to construct and forward to the Fetchers metadata requests for the status of graphical assets, the status of which has not been checked more recently than some defined point in the past. The Fetchers will then negotiate with the Metadata Providers' interfaces to determine whether continued retention of each of those assets is permitted, and forward removal requests or status updates to the Object-ID Service as appropriate.

Upon receiving a status update, the Object-ID Service 631 will note in the appropriate Database 620 that the status of the associated graphical asset is valid as of the time noted in said update. In contrast, upon receiving a removal request, the Object-ID Service will invalidate the associated graphical asset and instruct the Database to forward to the CDN 683 and Bulk Storage 684 a request to delete said asset.

### Internal Services

The Glidr Metadata Management System exposes Internal Services 640 that allow other internal Glidr systems (Internal Clients 650) to use Glidr's metadata.

### Program Match Service

The Program Match Service 641 attempts to determine the Glidr identifiers that correspond with programs in a customer's viewing history or Watchlist 651. This matching is necessary to determine whether two customers using different streaming providers have in fact watched the same program.

In many cases, the Program Match Service can rely on a simple correspondence between identifiers in the information obtained from the streaming provider and a Metadata Provider. Other cases require matching additional metadata information such as the program title, original air date, originating network, episode number, and the like.

### Optimization Support

The Optimization-Support Service 642 produces summaries of metadata relevant to the Budget Optimization process 652. For example, it can rank providers by metrics such as the availability and completeness of specific television series or the number of available programs in specific genres.

### External Services

The Glidr Metadata Management System exposes External Services 660 that allow Glidr Clients 692 to use Glidr's metadata. External Services include the Prefix Search Service 661 and the Metadata-Query Service 662.

To use a specific External Service, Glidr Clients send requests to the front end 680 of the Glidr Metadata Management Service, typically to a Load Balancer 681 that distributes the requests among one or more Application-layer Gateways 682. Acting as the external endpoint for Glidr Client requests, said Gateways provide security for the External Services 660 instances by isolating them from the open Internet, while simultaneously isolating the Glidr Clients from changes to the External Services interfaces.

In the preferred embodiment, said Gateways also act to authenticate the Glidr Client originating each query, forwarding to the External Services only validated queries from authorized Glidr Clients.

### The Prefix Search Service

The Prefix Search Service 661 provides very fast browsing of program and celebrity names by entering just a few letters at the beginning of one or more words in the name. This Service is intended to facilitate program and celebrity searching in an environment—such as a mobile device—where data entry can be cumbersome.

In one embodiment, the Prefix Search Service uses an in-memory radix trie (also called a “radix tree”) that indexes a plurality of permutations of all the program and celebrity names, along with the likely relevance a customer might assign to each name. Recent search results are also cached to further enhance the speed of response in certain very common cases, such as:

The user enters a single letter, thus requesting, for example, the most popular 20 celebrities whose name begins with the letter “S”. Essentially all prefix searches will begin with a search for a single letter, so most of these otherwise expensive searches can be fulfilled from the cache.

The user erases their last typed character, thus re-performing their own penultimate search operation. This embodiment allows the system to search a multitude of names and return the most relevant matches within a time interval substantially comparable to that required for the user to type the next character.

The Prefix Search Service 661 initializes the radix trie by enumerating all of the relevant program and celebrity metadata currently in the Databases 620. Whenever the Metadata Indexer 615 is considered to have committed a sufficient number of modifications to the Databases, it sends an Update Notification to the Prefix Search Service instructing it to refresh the relevant portion of its in-memory data.

Each response from the Prefix Search Service includes a list of matching names or titles, if any, and an indication of the total number of matches available—often far more than the limited number actually returned. In addition to the actual name of the item, each match includes a small amount of associated information such as the unique identifier Glidr assigned to the associated metadata item and minimal disambiguating information to include in the results displayed to the user. For example, display of a movie title might include information such as the original release date, run time, and rating. Similarly, display of a celebrity name might include information such as the celebrity's gender and birth and death dates, if appropriate.

### The Metadata Query Service

The Metadata Query Service 662 exposes more detailed metadata to the Glidr Clients 692. To retrieve detailed metadata, said Clients compose queries based on information—such as a Glidr unique identifier for a program or celebrity—from previous search results to designate a specific type and instance of metadata said Clients wish to retrieve. Many types of information about specific programs or celebrities can be requested in this manner. For example, a Glidr Client can request descriptive details including, but not limited to, ratings, awards, or narrative descriptions, and for programs, availability data describing how to watch said program.

A Glidr Client can also request the unique identifiers of other associated metadata, such as any associated graphical assets or associated programs. Many types of program associations exist; for example, celebrities have associated credits, television series have seasons and episodes, and movies have sequels. The Metadata Query Service does not return graphical assets, only their unique identifiers. Nevertheless, Glidr Clients can request graphical assets using said identifiers; the Load Balancer 681 directs said requests to the CDN 683.

### Search

As described above, when searching for shows or movies, the Glidr Search feature, as implemented in the search service 661, utilizes a prefix search technique to present the most likely content that the user is looking for. This is based on a number of factors including but not limited to popularity of the content, timeliness of the content, and key words in the titles. Further extensions of the Search technology can consider other sorting factors such as social buzz, as well as friends recommendations including chat topics.

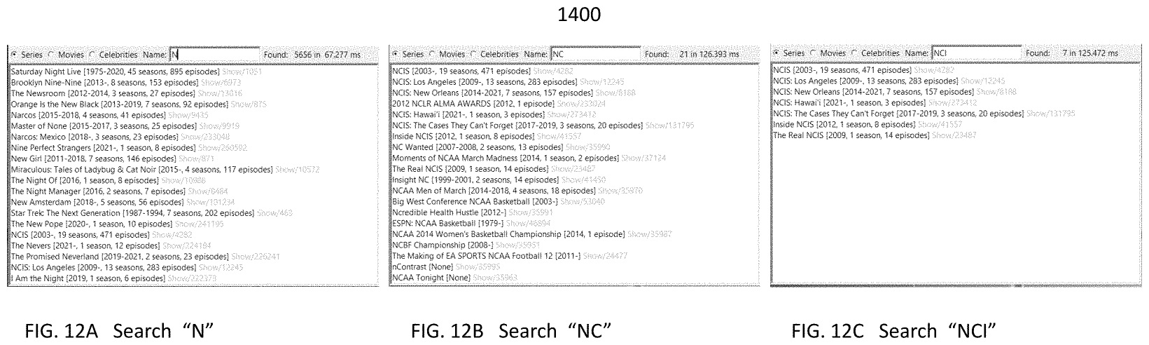

FIG. 12 illustrates the prefix search technique via a search demonstration and testing client 1400. In this case, the user is looking for the long running TV Series NCIS. In FIG. 12A, the user has entered the letter “N”, and brings up a variety of shows that have the letter N as part of their title. In FIG. 12B, the additional letter “C” has been entered, giving a prefix of “NC”. At this point the various NCIS TV series are at the top of the list. In FIG. 12C, by entering the letter “I”, giving a prefix of “NCI”, the list is limited to only the TV Series that are part of the NCIS franchise. With this technique, typically only a few letters need to be entered to find the shows, movies or celebrities being searched for. In accordance with various embodiments and aspects of the invention, searching for a specific show allows later recommendations to be fine-tuned to searches performed in the past. The system collects data as users search in order to identify and provide recommendations.

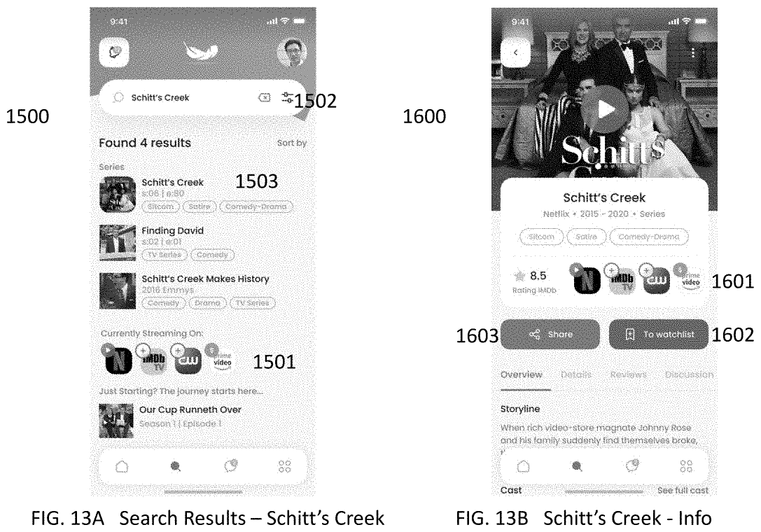

Results can be returned as a text list, a carousel of representative images, or any other form that presents the Search results 1500 in a usable form. This is illustrated in FIG. 13A where a search for the TV Series “Schitt's Creek” has been performed. As shown in this figure, multiple search results are returned, along with the streaming services 1501 that carry the TV Series. When a Search result is selected 1503, additional information can be displayed 1600 as shown in FIG. 13B, including but not limited to artwork, description, date, ratings, actors, episodes, service availability (services that carry the content) 1601 and deep links to the content or streaming service. Further, the TV Series can be added to the Glidr Watchlist 1602 or shared with Friends and Family 1603.

Various filters 1502 or sorting could be applied to narrow the search results. This includes but is not limited to genre, streaming service, date range, star rating, alphabetical, popularity, viewership rankings (ratings), or rising popularity (what's hot). Searches, along with filter settings, may be saved for future use, or to share with other Glidr members such as friends and family.

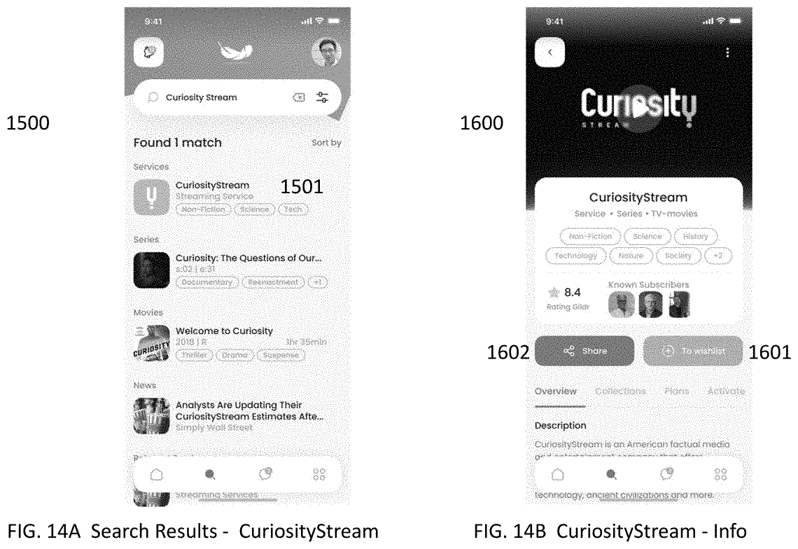

FIG. 14 shows a similar set of functionality for searching a streaming service. In FIG. 14A, the streaming service “Curiosity Stream” has been entered with one result 1501. In FIG. 14B, more information is presented about the streaming service. Similar to a TV Series, the streaming service can be added to the Glidr Wishlist 1601 or shared with Friends and Family 1602. Content can also be browsed based on similarity. Recommendation engines such as 115 can also be used to present Glidr search results. Editorial commentary regarding content recommendations can also be factored into the search engine 103.

Streaming services can also be found with the Glidr Search feature. Many of the same search criteria can be applied as described above. In a similar fashion, if a streaming service is selected, a service information screen can be displayed. This could include but is not limited to current subscription status, viewing plans and cost, general description of content, popular titles, branding images, trailers, and monthly promotion videos. Further, options can be presented for Subscribe, Pause, Restart, and Cancel as appropriate.

Search results can be shared with friends and family, either directly via an internal Glidr message or chat room, email, or text messages. Search results can also be posted to popular social media sites such as Facebook or Twitter. The sharing of search results will include but not be limited to a metadata rich message including title, artwork, description, and deep links.

The Glidr Search feature is initially implemented as a text entry system but could be enhanced for voice search in the future.

### Social

The Glidr system 100 provides a robust set of social features for managing streaming video services. Much of the social interaction between Glidr users is illustrated in FIG. 3. Users can communicate with each other, either directly or as part of groups, they can share information about their streaming services, they can share wishlists and watchlists, they can provide recommendations and information regarding content and streaming services, and they can publish content.

Glidr will provide easy methods for posting information to the major social platforms such as YouTube, Facebook, Twitter, Snapchat, Pinterest, TikTok and others. For example, the user can post information about what they are watching or shows that they want to watch. It will be possible to share a deep link to a recommended show, along with rich metadata (title, description, rating images, etc.) for that show. Other information can be shared, limited only by what the user is willing to share on these public platforms.

Within the Glidr system itself, there is a broad set of social features. The Glidr system creates a new and novel social graph 500, 520, 540, 560 that combines user data from subscription services (which can be any of their data from the service and can include content they watched, content they recommend, content they want to watch, content they are currently watching, and services they subscribe to and have subscribed to) with that of other users that a first user U1 forms a social connection with.

Typically today, a user U1 can only access and look at their data for a service one service at a time and independent of the data from another service. Glidr, firstly, enables a user to access and look at their data from multiple services at the same time and in aggregate. Secondly, we also enable users to establish social connections with other users U2, U3, Un by, for example, a friending mechanism and then enable users to share their data with each other.

Thirdly, we can use the established social connections to link the data from one user U1 to the users they have a social connection with U2, U3 and then with the data those users have a social connection with and so on.

In this manner we create a unique social graph that links the service data of users with that of other users, and this social graph of linked data and users can be used to gain insight into common and different content consumption patterns across groups of users.

To get started with person-to-person social features, a Glidr user Un 521 must know another Glidr user's name, email, or phone number (for account identification). They may also invite their friends or family to join the Glidr community. To invite new Glidr users, a user must send an invitation by providing an email or phone number for the new user. This can be entered directly in the Glidr application 200 or determined from their contact list on the device. Once the new user has created their Glidr account, the user Un 521 will be informed of their membership and may engage in the social features with the new user.

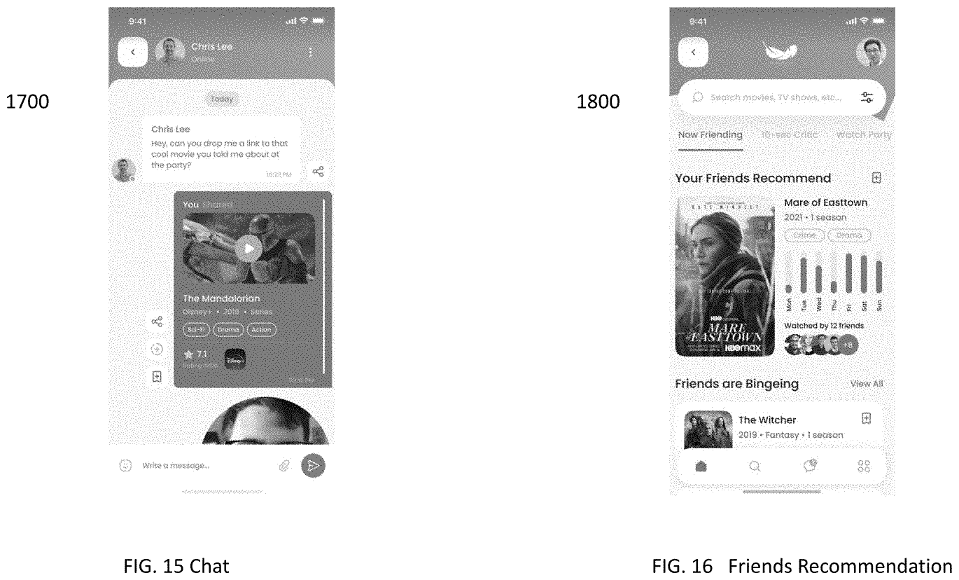

Once two members are linked as friends, such as users U1 523 and U3 524, they can engage in various social interactions such as Chat as shown in FIG. 15, sharing their streaming service Wishlist, content Watchlist, Recommendations for shows/movies/services (“Friend Sourced”) as shown in FIG. 16, and Search results. Watchlists may be filtered based on streaming service provider or other criteria. They may also wish to share streaming service accounts; in which case this information will be tracked in the Glidr application. Other information sharing use cases may also be included in the social feature set.

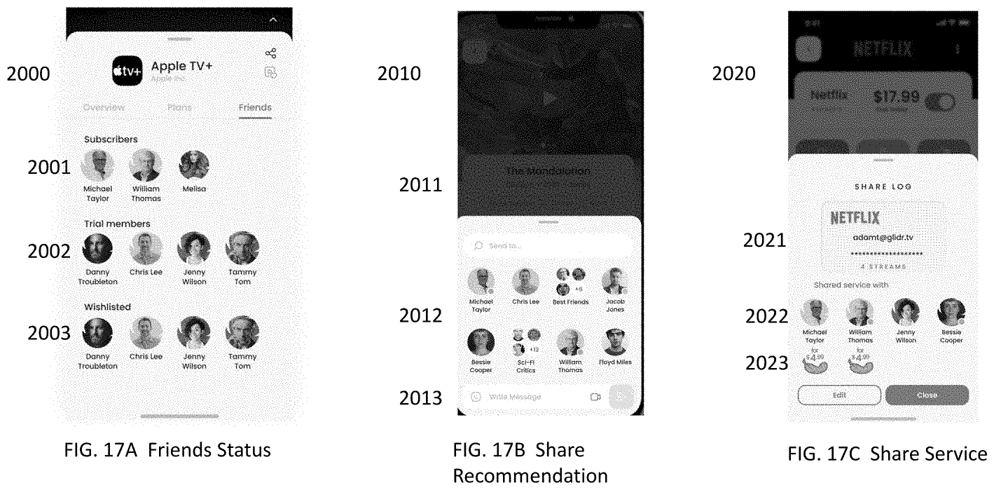

FIG. 17 shows more friends features. In FIG. 17A, the status of your friends is shown with regard to their streaming service status 2000. Information is provided regarding have they already subscribed 2001, are they trialing the service 2002, or have they wish listed the service 2003 for future consideration. In FIG. 17B a Recommendation 2010 for “Mandalorian” 2011 can be sent to your friends 2012, along with a message 2013 regarding the show. Also, in FIG. 17C information is provided regarding a service 2021 that is being shared with your friends 2022, along with cost sharing information 2023.

Beyond one-on-one friend's social communications, Glidr users can also create a private group (sometimes referred to as a Nest within the Glidr environment). Any number of friends or family can be in a group, and each Glidr user can be in multiple groups. It's expected that these groups will be relatively small, probably less than 10 participants on average, but there is no size restriction. All the Glidr social features can be performed within these groups. Various groups are illustrated on the Social Interaction plane 540 of FIG. 3. For example, users U3 524 and U2 522 have created the group 1_F&F 544. They may invite other Glidr users as appropriate. Also note that user U3 524 is also in group 1_Our Accounts 546 with user U1 523.

Within these groups, various chat topics may be discussed, although the intention is that the topics will focus on streaming content or services. For example, users may share information about what they are currently watching, or what shows they are anticipating the return of in the next season. This may involve sharing a Watchlist 1300, a Recommendation 2010, or their Wishlist 1103 of streaming services. It will be possible to share a deep link to a recommended show, along with rich metadata (title, description, rating images, etc.) for that show. It will also be possible to share deep links for subscribing to a streaming service or sharing your streaming service status. It will also be possible to engage in group viewing and commentary activities using the deep links provided. The system anticipates that some users may want to provide a video clip (a 10 Second Critic) which is an example of User Generated content 562. It will also be possible to share Glidr created content 506 in these groups. Note that Glidr will track what is shared and discussed in a user's group as an input to budget and service optimization processes.

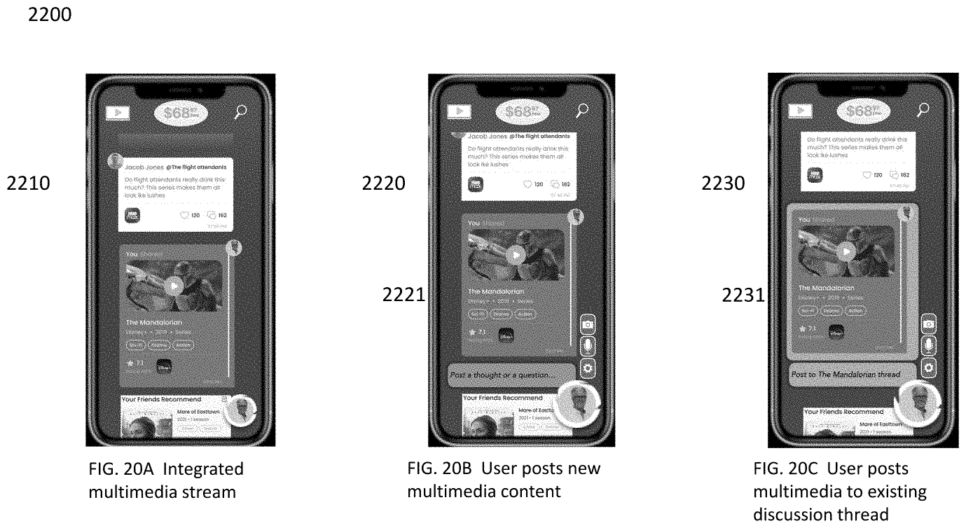

Glidr will provide consumers with a unique ability to browse multimedia posts and service notifications with an integrated social engagement experience. This is illustrated in FIGS. 20A, 20B, 20C. The intuitive design 2210 presents a method of viewing content recommendations, entertainment news and user-generated content that seamlessly blends with individual message boards and live chat with individuals and groups. This unique engagement model allows the user to participate in multiple, discrete discussion threads within a single user interface.

The unique experience is described as follows. The service provides a stream of content modules 2210 that contain images, videos and related media sourced from the Glidr service and from individual users. The user can contribute his own media-rich content and commentary to the stream and share it with other users connected to the service 2221. The user can also respond to the contributions from others by highlighting the selected content module and responding 2231. Multimedia content can be copied from any Glidr screen, or other source, and posted anywhere that is appropriate in the application. This same content can be posted in other social media applications, emails, or text messages.

Some users may wish to share streaming service account information, as illustrated in FIG. 17C, as indicated in the group 1_Our Accounts 546. This might be in support of having multiple viewing locations within a family, and the need to configure the viewing devices at each location. Or a group may want to share accounts, thereby increasing the effective budget for any one user. Any sharing of account credentials would be done in a highly secure fashion between the group members. This might involve direct messaging between users or sharing within the chat function of a group. By tracking the locations and devices, it is helpful to ensure that the maximum simultaneous stream limits are not exceeded for the streaming service and subscription level that is in use. Glidr can also facilitate cost sharing between users if they are so interested. Glidr and the users may use third party payment systems to facilitate cost sharing. Note that the streaming services have Terms Of Service that need to be understood by the users when contemplating any account sharing activities.

Another feature is the ability to subscribe or track individual users, such as famous people or influencers. Similar to how other social media platforms work, you will be able to follow their postings including shows that are watching, assuming they share such information. As mentioned above the Glidr system may identify personas that match your viewing interests, as such you could subscribe anonymously to these personas and share information as if you were in a small group.

### Other Features

The Glidr system 100 provides other important features for managing streaming video services. These include a viewing Guide, Notifications, Customer Loyalty Program, Paywall and Customer Support.

### Guide

In addition to the Service Management, Discovery and Social features described above, a Guide feature can be provided for the user. Depending on the content source there are various presentation techniques. This includes a conventional grid style display, a virtual grid, or visual carousels of content artwork presented based on a variety of categories such as but not limited to continue watching, new, ending soon, finish watching soon, popular, shows or movies, collections, recommended, and various genres. As another approach, multiple screens of content can be presented based on a hierarchy of similar categories.

Another Guide feature also includes shows, movies, and celebrity Search features such as described above. Once an item is selected, an information screen can be presented similar to what is described above for Search results.

The Guide features will be integrated into the Glidr application 200 in a logical fashion, so that the user can navigate between the Guide features and the other major Glidr features of Service Management, Discovery and Social.

### Notifications

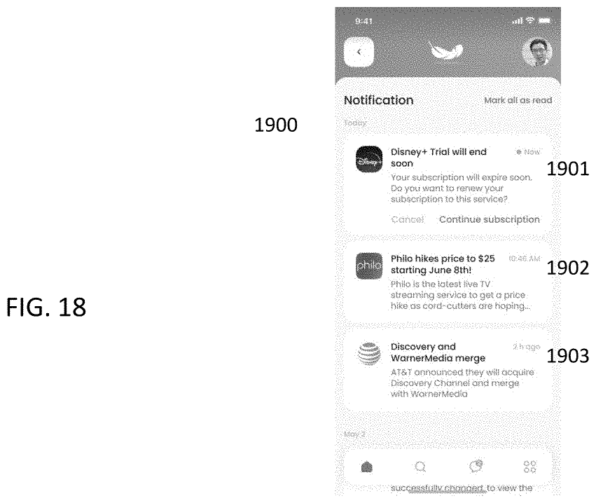

Notifications are an important feature presented throughout the Glide application 200. Notifications are managed by the Notification Server 117. Various forms of notification are presented such as badges, icons, and messages. Notifications can be communicated within the application or sent externally via email or text messages. FIG. 18 shows a Notification screen 1900.

Some of the notifications that will be provided are but not limited to new Glidr chat messages available, monthly activity/cost, free trial status 1901, monthly streaming service renewal status, upcoming new seasons (tied to the Watchlist), service pricing changes 1902 including special deals, industry news 1903, updated blogs, suggestions to change services, anything else that would affect the monthly cost, notification to friends or family about free trials or cost sharing opportunities, and what's new at Glidr.

Within the application, a numeric icon will show the number of pending notifications. As messages are read, the notification number will be decreased. Within each major component of the application, similar hints will be provided.

### Paywall

Paywall features may be added to the Glidr system 100 and application 200. These will fall into two general categories: 1) features available with a monthly subscription and/or 2) fees charged whenever costs savings occur as a result of using the Glidr feature set.

For the first category, based on research, the most valuable or widely used features may only be available if the user pays a monthly subscription fee. An example of a feature only available to a subscriber could be Budget Optimization. This fee is envisioned to cost much less than a subscription to any streaming service. The application will be built so its functional whether the user has subscribed or not. For a non-subscriber (free user), there may be upsell marketing messages and feature descriptions to encourage signing up for the monthly subscription and full feature set. Another approach is to provide a free trial period allowing access to the full feature set.

For the second category, another approach is to charge fees (micro transactions) whenever there is true cost savings provided by the Glidr system 100. An example of this could be based on managing streaming service cost sharing across family and/or friends. A small percentage of the cost savings would be charged to the user or users involved in the transaction. Another example could be a charge based on the monthly budget target that is being managed.

### Customer Loyalty Program

A Customer loyalty program will be established to encourage and reward users of the Glidr service 100. Examples of the benefits include the possibility of sharing streaming service sign up bounties back with the Glidr users. Subsidized streaming service subscriptions may also be offered. Defraying Paywall costs may also be provided for active Glidr users, or those that invite friends and family to join them as Glidr users. Glidr branded merchandise, such as hats, t-shirts, coffee cups may be offered to active users and successful recruiters of new Glidr users.

### Customer Support

Various customer support features will be available for Glidr Users. A Glidr website 107 will host many of these features, others may be supported directly through the Glidr application 200. This includes an extensive FAQ (Frequently Asked Questions) section. Demonstration videos will also show how to use some of the more important features of the Glidr system 100. A blog, or series of blogs from Glidr staff or users may be provided.

For providing support to Glidr users, a live chat feature, text or email, and telephone support may be offered. In addition, there may be a Facebook page and/or support forum website. Direct communications about Glidr features, special offers for Glidr users will be offered through the application or via email and text messages.

### Monetization

The Glidr application has many opportunities for monetization (revenue generation) based on the extensive feature set and value provided to users. Examples include but are not limited to the Paywall described above, Advertising and Promotion, Data Analytics, Streaming Service subscription bounties, and License fees from Distribution partners.

The Paywall, as described above, is a direct way to generate revenue from subscribers. However, its revenue generating potential needs to be weighed against having a potentially larger user base if all the Glide features are available to every user. The following revenue generation techniques would generally benefit from having the largest possible set of users.

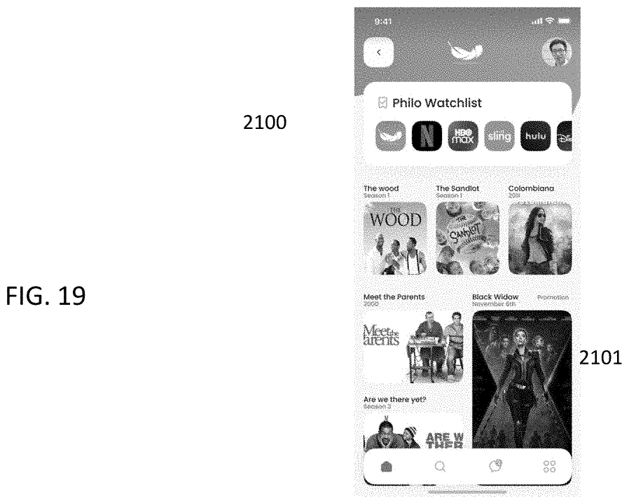

Advertising and Promotion is a well proven method to generate revenue. Of course, it's more successful the larger the potential audience (user base coupled with frequent engagement). Also, the advertising content needs to be appropriate for the benefits users see in using the Glidr service 100. For example, in FIG. 19, a promotion for “Black Widow” 2101 in presented on a Watchlist screen 2100. Given this requirement, advertising will likely be content, streaming service or streaming device promotion. For example, a new series starts or resumes. A well-known or new movie is now available on a streaming service, or content is moving from one streaming service to another. Streaming service bundles are another promotion opportunity. A new streaming device is now available at a great price. Given the extensive profile we will have for each user, targeted advertising can be implemented, and is unique to the Glidr user base. The Glidr advertising subsystem 116 would manage this functionality.

Data Analytics 108 is seen as a big opportunity for revenue generation as the user profiles and behavior the Glidr system 100 will measure are truly unique in the marketplace. Streaming providers have good insight on the behavior of their customers while they are subscribed and using their service, but they have no insight into how the same customers are using their competitors services, or what happens when they leave their streaming service. Further, the system will be able to observe cause and effect as customers churn between streaming services. These and other analytics will provide a valuable set of information for streaming services advertisers and other interested parties.

An important feature of the platform is the degree to which analytics can be developed concerning trends in user consumption of content and the services that provide the content. Subsystem 108 processes data captured within the system and synthesizes learnings, often turned into actions, which are commonly called analytics. The platform connects users and their content preferences with their social connections in a way that can be systematically examined and processed to elevate trends and learnings to where actions can be taken. In many cases actions are taken by the Glidr platform to the benefit of the Glidr user, such as presenting the user with recommendations 115 to cause them to reevaluate the service subscriptions they hold and make changes. Other uses include promotions and advertising 116 presented within the application. This same information is of value to service platforms so that they can change the content they procure 563, 564, the way they market their offering, or other aspects of their service such as pricing, subscription terms, trials etc.

Much of the data in the platform data bases 105 is structured data readily amenable to processing, such as the date a user cancelled the subscription with streaming service provider X and subscribed to streaming service provider Y. These simple related events are unambiguous and of interest to at least the providers X and Y, but also others. Other sources of explicit information from which inferences can be drawn are the intersection of user demographics and the time varying nature of programs available. Consider a household with no small children but which has adult(s) who have explicitly or implicitly expressed interest in the genre of “Science Fiction”. In the case where the streaming service provider has a large catalog of content such as the Disney content, and the user has watched all episodes of “The Mandalorian”, the user may decide to cancel or pause the Disney+ streaming service and subscribe to another streaming service Y, which has a large number of titles in their preferred genre. Again, this information is unambiguously deducible by algorithm from the users Watch History and the metadata concerning content availability.

A further source of data that can be used is the content generated by users of the platform through chat groups 110, 540 or content in publicly available news stories or influencers 567. Opinions can be expressed directly thorough “Like” and “Dislike” buttons, “Star ratings” or even the plain meaning of “emoticons” used. Lexicological analysis of words used, and frequencies can be noted, as are output of less explicit measures such as “Sentiment Analysis” such as from software tools such as those commercially available in the marketplace (EMOTICONS, LIWC, SentiStrength, Senti Wordnet, Senti Net, or Happiness Index among others.) Explicit recommendations from friends and family are also known to significantly influence a user's opinion, so in addition to sentiments expressed, tying the sentiment to a source with a ranking of their influence is a useful piece of information for the analysis. The fact that a person of influence has subscribed to a service or watched a piece of content. or wishes to subscribe to a service or watch a piece of content, can influence a user without an explicit recommendation from the influencer. Because such lists of services and watched content are shared, and time spent viewing such screens known to 108, the system can synthesize insights explaining subsequent behaviors.

Below is a non-exhaustive list of data collected during the usage of the Glidr application 201,202.

General Metrics:
Total installs and signups and source attribution
Data sufficient to compute retention rates (date acct created, date acct deleted)
Active users (Daily Active Users, Weekly Active Users, Monthly Active Users.)
Engagement metrics by subscriber, total, average, and when, plus the following by total, average, per user, and when
Time spent on app—total and per session
Screens viewed, time spent on which screens, and screens visited per session
Performance metrics such as load times, response times, crashes, etc.
Device, OS, app & version (typical user agent data provided in iOS or Android)

Logged Metrics
Number of subscriptions tracked by app state (Active, Paused, Wishlist)
Number of passwords stored by users
Number of sign up, pause, cancel, restart links by Service with date stamp
Each budgeting scenario change is collected
Services selected, +/− changes, Search string, List selections, etc.
Budget state saved to backend when Budget Screen exited
Log on unique screens visited by unique ID
Log app invites and friend requests sent and accepted
Log of subscription passwords shared and average per user
Log of views of friends' watch history, watchlist, and services and time spent
Log actions taken from screens viewing friends account (share request, add service, subscribe, or wish list)
Log of free trials signed up for and conversion rate from promotions
Log of free trials shared and with whom
Log and rate of free trials canceled from expiration reminders
Log user generated content and viewership
For title, movie and celebrity searches, prefixes searched, and “dead ends”
Search matches for which detailed information is requested
Search requests for availability of content

The data logged and stored in 105, is subsequently used to create reports and visualizations of information by 108. A non-exhaustive list is:

Report Metrics
Number of views of subscription tracking dashboard
Number and type of subscription management actions taken (e.g., signup, pause, cancel, restart) and frequency
Fluctuation in number of subscriptions over time
Number of passwords stored and for which subscriptions
Percent and number of users who opt out of Glidr Data Services (where Glidr accesses user's data such as watch history from their subscriptions for the benefit of the user
Number of times budget is explored and frequency

Today, a common practice for many of the streaming services is to pay a new customer bounty to the referring partner. This is a one-time payment, so the revenue potential depends on having a steady flow of new customers. Glidr sponsored bundles may also offer another opportunity for bounty payments. As mentioned above, while bounties could certainly generate revenue, it's also possible that Glidr may use these funds to reward loyal users of the Glidr system 100.

License fees from Glidr distribution partners such as broadband Internet Service Providers (ISPs), or device manufacturers such as streaming players or Smart TVs are another revenue generating opportunity. These could be one-time or recurring revenue per device. Further, revenue sharing based on active customer base may be a factor in encouraging these distribution channels.

Practitioners skilled in the art will recognize many possible modifications and variations. The modifications and variations include any relevant combination of the disclosed features. Descriptions herein reciting principles, aspects, and examples encompass both structural and functional equivalents thereof.

Various embodiments are methods that use the behavior of either or a combination of humans and machines. The behavior of either or a combination of humans and machines (instructions that, when executed by one or more computers, would cause the one or more computers to perform methods according to examples described and claimed and one or more non-transitory computer readable media arranged to store such instructions) embody methods described and claimed herein. Each of more than one non-transitory computer readable medium needed to practice the invention described and claimed herein alone embodies the invention. Method embodiments are complete wherever in the world most constituent steps occur. Some embodiments are one or more non-transitory computer readable media arranged to store such instructions for methods described herein. Whatever entity holds non-transitory computer readable media comprising most of the necessary code holds a complete embodiment. Some embodiments are physical devices such as semiconductor chips; hardware description language representations of the logical or functional behavior of such devices; and one or more non-transitory computer readable media arranged to store such hardware description language representations.

Although the invention has been shown and described with respect to a certain preferred embodiment or embodiments, it is apparent that equivalent alterations and modifications will occur to others skilled in the art upon the reading and understanding of this specification and the drawings. Practitioners skilled in the art will recognize many modifications and variations. The modifications and variations include any relevant combination of the disclosed features. In particular regard to the various functions performed by the above described components (assemblies, devices, systems, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments. In addition, while a particular feature may have been disclosed with respect to only one of several embodiments, such feature may be combined with one or more other features of the other embodiments as may be desired and advantageous for any given or particular application.

Some embodiments of physical machines described and claimed herein are programmable in numerous variables, combinations of which provide essentially an infinite variety of operating behaviors. Some embodiments herein are configured by software tools that provide numerous parameters, combinations of which provide for essentially an infinite variety of physical machine embodiments of the invention described and claimed. Methods of using such software tools to configure hardware description language representations embody the invention described and claimed. Physical machines can embody machines described and claimed herein, such as: semiconductor chips; hardware description language representations of the logical or functional behavior of machines according to the invention described and claimed; and one or more non-transitory computer readable media arranged to store such hardware description language representations.

In accordance with the teachings herein, a client device, a computer and a computing device are articles of manufacture. Other examples of an article of manufacture include: an electronic component residing on a motherboard, a server, a mainframe computer, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods.

An article of manufacture or system, in accordance with an embodiment of the invention, is implemented in a variety of ways: with one or more distinct processors or microprocessors, volatile and/or non-volatile memory and peripherals or peripheral controllers; with an integrated microcontroller, which has a processor, local volatile and non-volatile memory, peripherals and input/output pins; discrete logic which implements a fixed version of the article of manufacture or system; and programmable logic which implements a version of the article of manufacture or system which can be reprogrammed either through a local or remote interface. Such logic could implement a control system either in logic or via a set of commands executed by a processor.

Furthermore, examples and conditional language recited herein are principally intended to aid the reader in understanding the principles of the invention and the concepts contributed by the inventors to furthering the art and are to be construed as being without limitation to such specifically recited examples and conditions. Moreover, statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

The foregoing is merely illustrative of the principles of this invention and the scope of the invention is not limited by the detailed embodiments of the description The scope of the invention, therefore, is not intended to be limited to the exemplary embodiments or the various aspects shown and described herein. Rather, the scope and spirit of the present invention is embodied by the appended claims.

What is claimed is:

1. A system for managing streaming content, the system comprising:
at least one processor;
a database, which is in communication with the processor, for storing information about a user;
a profile service, which is in communication with the processor, for generating a user account that is unique to the user and the user account is based on the user's information;
an application service, which is in communication with the processor, for communicating with the user's device and a plurality of streaming content providers; and
a login service, which is in communication with the processor, for accessing and retrieving information from at least one of a plurality of streaming content providers,
wherein system accesses each of a plurality of streaming content providers on behalf of the user to collect data related to the user's content consumption at each of the plurality of streaming content providers in order to provide to the user a recommendation related to consumption of content at any one or more of the plurality of streaming content providers.

2. The system of claim 1 further comprising a proxy module, which is in communication with the processor, for collecting information related to the user's consumption of the content over multiple sessions, including at least one of viewing history, favorite shows or movies, and watch list, from each of the plurality of streaming content providers.

3. The system of claim 1 further comprising a credential locker for storing a plurality of user credentials, one for each of the plurality of streaming content providers.

4. The system of claim 1, wherein the system is in communication with a virtual private network (VPN) to allow the user to have a digital presence in multiple locations.

5. The system of claim 1, wherein the database stores metadata related to content consumed by the user at each of the plurality of streaming content providers.

6. The system of claim 1, wherein the information about the user includes personal data.

7. The system of claim 1 further comprising a content module, which is in communication with the processor, for importing third party content that is stored in the database.

8. The system of claim 7, wherein the content module transforms the third-party content before storing it and captures metadata about at least one of: programs, episodes, movies, actors, directors, channels, service providers, opinion, reviews from critics, reviews from influencers, and content from reporters.

9. The system of claim 1 further comprising a machine learning model for analyzing the user's consumption of content and providing feedback to the user for future content consumption.

10. The system of claim 1 further comprising a tracking module, which is in communication with the processor, for analyzing costs associated with each of the plurality of streaming content providers, wherein the tracking module recommends to the user options for management of the plurality of streaming content providers.

11. The system of claim 10, wherein the options include at least one of subscribing, pausing, and cancelling at least one of the plurality of streaming content providers in order to financially optimize the user's spending budget.

12. The system of claim 11, wherein the options are based on at least one of: service level, cost, billing period, usage, viewing history, watch list, suitable services, video content of interest, watchlists, popular social trending content, and recommendations from other users.

13. A method for managing consumption of content provided by a plurality of streaming service providers, the method comprising:
storing information about a user;
generating a user account that is unique to the user, wherein the user account is based on the stored user information;
accessing, on behalf of the user, a plurality of streaming service providers used by the user;
retrieving, from the plurality of streaming service providers, information about the user in order to collect content consumption information including the user's content consumption at each of the plurality of streaming service providers;
analyzing the content consumption information retrieved from the streaming service providers; and
providing, based on the analysis, a recommendation to the user related to future consumption of content at any one or more of the plurality of streaming service providers in order to optimize the user's future content consumption experience.

14. The method of claim 13, wherein the recommendation is based on at least one of: service level, cost, billing period, usage, and continuous viewing duration.
